(19) United States
(12) Patent Application Publication
(10) Pub. No.: US 2026/0368640 A1
(43) Pub. Date: Nov. 19, 2026

(54) DYNAMIC PARAMETER OPTIMIZATION

(71) Applicant: University of Virginia Patent Foundation, Charlottesville, VA (US)

(72) Inventors: Matthew Korban, Charlottesville, VA (US); Scott T. Acton, Charlottesville, VA (US)

(21) Appl. No.: 19/657,895

(22) Filed: Apr. 24, 2026

Related U.S. Application Data
(60) Provisional application No. 63/794,899, filed on Apr. 25, 2025.

(51) Int. Cl. G06N 20/00

(52) U.S. Cl. CPC G06N 20/00

(57) ABSTRACT

Disclosed are various embodiments for identifying a subset of parameters from a set of parameters corresponding to a neural network and proposing an updated subset of parameters based at least in part on applying a mean field update to the subset of parameters. Further disclosed are embodiments for determining a set of acceptance probabilities based at least in part on a temperature value and a set of energy differences between the subset of parameters and the updated subset of parameters and accepting one or more updated parameters from the updated subset of parameters, based at least in part on the set of acceptance probabilities.

### CROSS REFERENCE TO RELATED APPLICATIONS

This application claims priority to U.S. Provisional Patent Application No. 63/794,899, filed on Apr. 25, 2025, entitled “Dynamic Generalized Deterministic Annealing Optimization System for Enhanced GPU-Based Deep Learning Computation”, which is incorporated herein by reference.

### STATEMENT REGARDING FEDERALLY SPONSORED RESEARCH OR DEVELOPMENT

This invention was made with government support under Grant No. 2322993 awarded by the U.S. National Science Foundation. The government has certain rights in the invention.

### BACKGROUND

Machine learning is a broadly used technique across various research areas and industries. Machine learning generally allows the creation of programs capable of executing functionality not hard-coded into the program itself. The programs can be designed to achieve this extended functionality by automatically adjusting parameters corresponding to a machine learning model such that outputs of the model more accurately align with a set of goals. The manner by which the parameters are adjusted can influence the success of the machine learning model.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a computing environment according to various embodiments of the present disclosure.

FIG. 2 is a sequence diagram illustrating one example of functionality implemented between portions of applications executed in the computing environment of FIG. 1 according to various embodiments of the present disclosure.

FIG. 3 is a flowchart illustrating one example of functionality implemented as portions of an application executed in the computing environment of FIG. 1 according to various embodiments of the present disclosure.

FIG. 4 is a flowchart illustrating one example of functionality implemented as portions of an application executed in the computing environment of FIG. 1 according to various embodiments of the present disclosure.

FIG. 5 is a table comparing five optimization techniques according to various embodiments of the present disclosure.

FIG. 6 is a table listing machine learning models and corresponding datasets wherein the pairings are relevant to various embodiments of the present disclosure.

FIG. 7 is a table comparing six optimization techniques according to various embodiments of the present disclosure.

FIG. 8 is a table comparing two machine learning approaches according to various embodiments of the present disclosure.

FIG. 9 is a table comparing three temperature schedules according to various embodiments of the present disclosure.

FIG. 10 is a table comparing six optimization techniques according to various embodiments of the present disclosure.

FIG. 11 is a table comparing two optimization techniques according to various embodiments of the present disclosure.

FIG. 12 is a graphical diagram comparing two optimization techniques according to various embodiments of the present disclosure.

FIG. 13 is a graphical diagram comparing six optimization techniques according to various embodiments of the present disclosure.

FIG. 14 is a graphical diagram comparing an optimization technique across five data sets according to various embodiments of the present disclosure.

FIG. 15 is a graphical diagram comparing an optimization technique across four data model state counts according to various embodiments of the present disclosure.

FIG. 16 is a graphical diagram comparing two optimization techniques according to various embodiments of the present disclosure.

FIG. 17 is a graphical diagram comparing two optimization techniques according to various embodiments of the present disclosure.

FIG. 18 is a graphical diagram comparing two optimization techniques according to various embodiments of the present disclosure.

FIG. 19 is a pictorial diagram comparing traditional optimization algorithms to block-wise based optimization according to various embodiments of the present disclosure.

### DETAILED DESCRIPTION

Disclosed are various approaches for improved parameter optimization in machine learning. Optimization is central to classical and modern machine learning. This disclosure introduces Dynamic Fractional Generalized Deterministic Annealing (DF-GDA), a physics-inspired algorithm that boosts stability and speeds convergence across a wide range of models, especially deep networks. Unlike traditional methods such as Stochastic Gradient Descent, which may converge slowly or become trapped in local minima, DF-GDA can employ an adaptive, temperature-controlled schedule that balances global exploration with precise refinement. Its dynamic fractional-parameter update can selectively optimize model components, improving computational efficiency. The method can excel on high-dimensional tasks, including image classification, and also strengthens simpler classical models by reducing local-minimum risk and increasing robustness to noisy data.

Extensive experiments on sixteen large, interdisciplinary datasets, including image classification, natural language processing, healthcare, and biology, show that DF-GDA consistently outperforms both state-of-the-art and traditional optimizers in convergence speed and accuracy, offering a powerful alternative for critical large-scale, complex problems across diverse scientific and industrial settings today.

Optimization is fundamental in many scientific and engineering fields and is crucial in finding the best solutions to various problems. It aims to adjust the parameters of a system to maximize or minimize a particular function, known as the objective function. This process is essential in numerous applications, including logistics, finance, healthcare, manufacturing, and others, where achieving optimal performance or efficiency is the primary goal.

In the context of machine learning, optimization is critical. Machine learning models, including classical methods such as k-means clustering and support vector machines, learn from data by adjusting their parameters to minimize a loss function. This function measures how well the model's predictions match the actual data. Practical optimization algorithms are vital for training these models efficiently and accurately. With proper optimization, machine learning models may converge to a suitable solution, leading to better performance and accurate predictions.

Deep learning, a subset of machine learning, involves training large neural networks with many layers and millions of parameters. Due to the complexity and size of these models, the role of the optimization process in deep learning is even more critical. Deep learning models can achieve remarkable performance in tasks such as image recognition, natural language processing, and video understanding, but only if optimized effectively. The challenges in deep learning optimization include avoiding local minima, managing high-dimensional parameter spaces, and ensuring fast and stable convergence.

Traditional optimization methods such as Stochastic Gradient Descent (SGD) and adaptive moment estimation (ADAM) are widely used in deep learning due to their simplicity and effectiveness. However, these methods often face challenges, such as being trapped in local minima and slow convergence when dealing with high-dimensional parameter spaces and noisy data. To address these issues, more advanced optimization techniques are necessary.

Genetic algorithms introduced feature optimization in specific domains but were computationally expensive and prone to slow convergence. Nature-inspired algorithms such as Harris Hawks optimization and Firefly optimization further advanced the field by automating hyperparameter tuning and improving convergence rates. However, these techniques still demanded significant computational resources and carried the risk of entrapment in local minima and susceptibility to annotation noise (errors or inconsistencies in data labeling). Consequently, due to these limitations, they did not achieve the widespread adoption seen with methods such as SGD and ADAM.

Proposed in this disclosure is a novel optimization algorithm, namely Dynamic Fractional Generalized Deterministic Annealing (DF-GDA), to enhance convergence speed and efficacy in deep learning models. DF-GDA also shows high potential for significantly improving classical machine learning algorithms such as Support Vector Machines (SVMs) and k-means clustering, which can benefit from its robust handling of local minima and efficient exploration-exploitation balance. This approach builds on the core principles of generalized deterministic annealing (GDA), which include a temperature-dependent probabilistic acceptance criterion and a mean field estimation process to estimate the values of unknown variables. The temperature-dependent acceptance criterion helps balance exploration and exploitation during the optimization, significantly reducing the risk of being trapped in local minima.

The proposed DF-GDA algorithm can dramatically improve the performance of deep network models in complex research problems, including interdisciplinary applications such as image classification, video understanding, bioinformatics, healthcare analytics, and natural language processing. These are optimization landscapes characterized by multiple local minima where traditional gradient-based methods such as Stochastic Gradient Descent (SGD) have long been considered indispensable. This approach demonstrates the potential to significantly surpass them, representing a major advancement in optimization across a broad range of scientific and engineering domains.

Although effective for image processing tasks, the original GDA method was not designed for deep learning or machine learning optimization tasks. Significant modifications were necessary to adapt GDA for the specific needs of machine learning and deep network optimization, making it suitable for large-scale deep learning applications. These adaptations involved incorporating the dynamically adjustable fraction parameter, leveraging mean-field gradient estimates, and implementing a soft quantization mechanism to ensure parameter updates remain within feasible ranges.

DF-GDA introduces a new dynamically fractional parameter update (DFPU) algorithm to further enhance GDA for deep learning applications. This adaptive algorithm takes advantage of the proportion of model parameters that are to be updated during each iteration. It can be sensitively adjusted on the basis of the current status of the training, including the rate of change in the loss function. This adjustment ensures a balanced trade-off between exploration and exploitation throughout training. The proposed approach makes the high-dimensional parameter space significantly more manageable, a persistent problem in deep learning optimization.

The proposed DFPU is essential to the learning process, as it is applied during the optimization and backward pass stages. This can differentiate it from dropout, a regularization technique that is used only during the forward pass. This new method, applied during the backward pass, ensures broader applicability, whereas dropout is limited because it only functions during the forward pass. Since the forward pass does not directly influence parameter updates, its applicability in optimization is more restricted. In particular, DFPU also reduces the computational cost more effectively than dropout. Although dropout only prevents specific neurons from updating and primarily addresses overfitting, it does not reduce computational workload. In contrast, the new method achieves both objectives: it selectively ignores a large portion of parameters, lowers computational cost, and prevents overfitting in a more adaptive way than dropout.

The proposed DF-GDA enhances robustness to annotation noise, particularly in mislabeled data, by using fractional parameter updates, soft quantization, and adaptive temperature control. By updating a subset of parameters per iteration, DF-GDA limits the influence of noisy samples, while soft quantization smooths parameter transitions to maintain stability. Its entropy-driven temperature adjustments support broader exploration early in training, helping the model avoid suboptimal solutions caused by annotation noise.

“Nature-inspired” meta-heuristics (e.g., Genetic Algorithms, Particle Swarm, Ant-Colony) explore via large populations, use little or no gradient information, and require hand-tuned parameters for exploration versus exploitation. By contrast, DF-GDA performs deterministic, gradient-guided updates on an entropy-chosen subset of parameters and injects controlled randomness through an adaptive temperature test. This design (i) slashes per-step cost from population-wide evaluations to a small fraction of the parameters, (ii) speeds convergence because every accepted move follows the local gradient, and (iii) self-balances exploration and exploitation via the entropy schedule. These differences remove the slow convergence, heavy computation, and parameter sensitivity that hamper classical nature-inspired methods, explaining DF-GDA's superior accuracy and efficiency in the experiments.

Some contributions of this disclosure are as follows: Introduced here is DF-GDA, a novel optimization algorithm for deep learning that enhances convergence speed, stability, and robustness to annotation noise, outperforming traditional methods like SGD, particularly in complex problems prone to local minima. Proposed also is a Dynamic Fractional Parameter Update (DFPU), an efficient algorithm integrated into DF-GDA that selectively updates model parameters based on network performance. GDA is adapted for deep network optimization, addressing specific challenges in deep learning. DF-GDA is validated through comprehensive experiments on sixteen diverse datasets, including image classification, healthcare, bioinformatics, and NLP, demonstrating superior convergence speed and accuracy compared to state-of-the-art and traditional optimizers. This includes the large-scale ImageNet and Kinetics-700 datasets. Demonstrated are DF-GDA's potentials in classical machine learning tasks like SVM and k-means clustering. Provided is a rigorous theoretical foundation supporting the disclosed methodology.

Optimization is a fundamental task in machine learning and deep learning models, where the goal is to minimize a loss function ƒ(θ) with respect to the model parameters θ. Gradient-based optimization methods are widely employed for this purpose, leveraging the gradient (first-order derivatives) of the loss function to update the parameters iteratively.

The basic gradient descent (GD) algorithm computes the gradient of the loss function ƒ(θ) with respect to the parameters and updates the parameters in the direction that decreases the loss with a learning rate η. The update rule is given by: θₜ₊₁=θₜ−η∇₀ƒ(θₜ).

Despite its simplicity, GD can become inefficient for large datasets, requiring a complete pass over the entire dataset at each iteration. To address this challenge, this disclosure moves to stochastic gradient descent (SGD), which offers a more efficient alternative. SGD computes the gradient based on a single randomly chosen data point (or a small batch of data), significantly reducing the computational cost per iteration. While SGD improves efficiency, the noisy updates can lead to instability in convergence. To mitigate this instability, researchers often employ mini-batch gradient descent, a compromise between GD and SGD that further stabilizes the optimization process. Mini-batch gradient descent computes the gradient over a small batch of data points B, offering a balance between the computational efficiency of SGD and the stability of GD. The update rule becomes:

$${θ}_{t + 1} = {θ}_{t} - η \frac{1}{\vert B \vert} {Σ}_{i ∈ B} {∇}_{θ} f ( {θ}_{t} ; {x}_{i} ) .$$

While this variant improves efficiency and stability, particular optimization challenges remain, remarkably when the gradient oscillates or slows down near optima. Techniques such as momentum are introduced to address these. Momentum accelerates convergence by smoothing the update direction using an exponentially decaying average of past gradients, where the degree of influence from past gradients is controlled by the weighting factor β. This allows the optimizer to overcome oscillation and gain speed in the proper direction. The update rule with momentum is: vₜ₊₁=βvₜ+(1−β)∇_{θ}ƒ(θₜ).

Although gradient-based methods are highly effective for many optimization tasks, they can struggle with nonconvex problems where multiple local minima exist, potentially leading to suboptimal solutions. Nonconvexity is a common characteristic of many modern problems, particularly deep learning. In such cases, simulated annealing (SA) offers an alternative by allowing probabilistic exploration of the solution space, which helps in escaping local minima and finding better global optima. SA is a probabilistic technique for approximating the global optimum of a given function, inspired by the physical annealing process in metallurgy. The core idea is to explore the solution space randomly at high temperatures, allowing uphill moves (increases in the objective function) to avoid local minima. As the temperature decreases, the algorithm gradually favors downhill moves, leading to convergence to a local or global minimum. The probability of moving from solution i to j at temperature T follows:

$$P ( i , j , T ) = exp ( \frac{E ( i ) - E ( j )}{T} )$$

where E(i) and E(j) represent the energies (or costs) of solutions i and j, respectively.

Generalized deterministic annealing SA has been successfully applied to numerous nonconvex optimization problems, but its stochastic nature, serial updating, and associated computational cost can make it impractical for large-scale problems. Precisely due to its stochastic nature, it often requires a significant number of iterations to converge. In fact, to guarantee a global optimum, the annealing schedule is as expensive as an exhaustive search of the solution space. Furthermore, it struggles with the high computational cost of maintaining random sampling over vast solution spaces and can be prone to erratic convergence behavior in some instances.

To overcome the inefficiencies and convergence issues of SA, generalized deterministic annealing (GDA) was introduced as a more efficient, deterministic alternative. While GDA retains the core principles of SA, such as temperature-dependent exploration of the solution space, it replaces the stochastic updates with deterministic rules that reduce computational complexity. By utilizing local Markov chains, GDA transitions between solutions more systematically, leading to faster convergence and avoiding the erratic behavior sometimes associated with SA.

GDA employs K-state neurons to represent the probability densities of local Markov chains, iteratively updating these densities. This iterative process is captured by the update equation:

$${π}_{n}^{t + 1} ( j ) = {Σ}_{i = 0}^{K - 1} {P}_{n} ( i , j , T ) {π}_{n}^{t} ( i ) .$$

where

$$p {i}_{n}^{t} ( j )$$

is the probability density of the nth neuron being in state j at iteration t, and Pₙ(i, j, T) is the transition probability at temperature T.

An acceptance function governs these transitions, ensuring that lower-energy states are favored as the temperature decreases. The transition probability balances exploration and exploitation during optimization. This probability is determined by two key components: the generation function, which proposes new candidate states, and the acceptance function, which decides whether to accept the new state based on the change in energy (or loss) and the current temperature. The transition probability from state i to j at temperature T is given by: P(i, j, T)=G(I, j). A(I, j,T).

This mechanism enables GDA to converge to high-quality solutions more efficiently than SA. While SA explores the entire state space and requires O((KN)²) steps for convergence, GDA achieves the same with O(KN) updates by focusing on localized Markov chains and deterministic updates, significantly reducing computational complexity. This makes GDA particularly well-suited for large-scale optimization problems where local constraints dominate. Empirical results demonstrate that GDA outperforms both SA and local search methods regarding solution quality and computational efficiency.

The original GDA algorithm effectively solved discrete optimization problems like image restoration through deterministic state transitions that minimize energy functions. However, modern deep learning presents new challenges with its continuous, high-dimensional parameter spaces. To adapt GDA for these contexts, this disclosure introduces two key modifications: soft quantization, which enables probabilistic parameter representation in continuous spaces, and dynamic fractional updates, allowing simultaneous adjustment of multiple parameters. These enhancements preserve GDA's exploratory capabilities while improving its efficiency and scalability for deep learning applications.

Training deep neural networks presents significant challenges due to the nonconvex nature of the loss landscape, which is characterized by numerous local minima, saddle points, and flat regions. Standard optimization methods, such as SGD, can converge slowly or become trapped in suboptimal solutions, particularly when applied to large models. To address this issue, proposed is a new method, namely, a dynamic fractional generalized deterministic annealing (DF-GDA) algorithm based on the principles of the GDA algorithm opting for a deterministic approach that allows the acceptance of solutions with higher loss values during the early stages of training. This controlled tolerance of the loss function facilitates broader exploration of the solution space, helping the optimizer to escape local minima and improve overall convergence.

The proposed DF-GDA elevates the original GDA algorithm by integrating a novel dynamic fractional parameter update mechanism and soft quantization to enhance computational efficiency and convergence speed, making it more compatible with modern deep learning models. By dynamically adjusting the fraction of parameters updated and applying soft quantization, DF-GDA allows for a more controlled exploration of the parameter space, balancing exploration and exploitation to accelerate convergence.

Let θ∈( [symbol] )ⁿ represent the set of parameters in the neural network, where n is the total number of parameters. The goal is to minimize a nonconvex loss function L(θ), which measures the error between the model's predictions and the ground truth:

$$\begin{matrix}min \\ θ\end{matrix} L ( θ ) .$$

Due to the nonconvex nature of L(θ), standard gradient-based methods are prone to being trapped in local minima. DF-GDA uses a temperature T and dynamically adjusts the fraction of parameters updated at each iteration to balance exploration and exploitation. In DF-GDA, the optimization process is guided by the energy function E(θ,T), a function of the loss L(θ) and the temperature T. The energy function is expressed as:

$$E ( θ , T ) = L ( θ ) + \frac{λ}{T} {Σ}_{i = 1} n \vert {θ}_{i} = {θ}_{i}^{′} \vert$$

where n is the number of parameters, λ is a regularization parameter, and θᵢ′ are the potential new states of the parameters after applying soft quantization.

DF-GDA incorporates a novel soft quantization strategy to constrain parameter updates and ensure smoother transitions. For each parameter θᵢ, soft quantization projects the parameter onto a set of K quantized states Q={q₁, q₂, . . . , q_{K}}, where the probability of θᵢ assuming a quantized state qₖ is given by:

$$S ( {θ}_{i} ) = {Σ}_{k = 1}^{K} {q}_{k} \frac{exp ( \frac{\vert {θ}_{i} - {q}_{k} \vert}{T} )}{{Σ}_{j = 1}^{K} exp ( \frac{\vert {θ}_{i} - {q}_{k} \vert}{T} )} .$$

where T controls the quantization level between soft and hard. Higher temperatures result in softer (less sharp) quantization, allowing parameters to explore a broader range of values.

As the temperature decreases, the quantization becomes sharper, making the parameter updates more deterministic. Soft quantization balances continuous space optimization with the stability of discrete space updates, preventing large, abrupt parameter jumps in high dimensional problems like deep neural networks. Unlike hard quantization, which forces parameters to snap to the nearest state, soft quantization allows them to probabilistically explore nearby states, promoting smoother transitions while maintaining structure and stability. This approach enhances both flexibility and robustness in parameter updates.

Soft quantization shares a mathematical resemblance to the softmax function, as both use an exponential normalization term. However, while softmax is primarily used for probability distribution in classification, soft quantization ensures smooth transitions between discrete quantized states in optimization.

For problems requiring high precision across a wide parameter range, a larger K allows for finer resolution in the parameter space. Conversely, a smaller K is suitable for less complex tasks or when prioritizing computational efficiency, resulting in coarser exploration. At each iteration, the derivative of the loss function ∇L(θᵢ) is updated using the mean field approach to smooth over time:

$${μ}_{i}^{( t + 1 )} = {μ}_{i}^{( t )} + ( 1 - α ) ∇ L ( {θ}_{i}^{( t )} )$$

where α is a smoothing coefficient that controls how much current values are weighted versus the historical average.

Once the mean field is computed, the parameters are updated by applying soft quantization:

$${θ}_{i}^{( t + 1 )} = S ( {θ}_{i}^{( t )} - η {μ}_{i}^{( t )} + ∈ ( T ) \cdot 𝒩 ( 0 , I ) )$$

where η is the learning rate. ϵ(T) is a temperature-dependent scaling factor. The term ϵ(T)· [symbol] (0, I) introduces Gaussian noise (with mean 0 and identity covariance I), scaled by temperature T. P(i, j, T) is the transition probability that will be explained as follows.

Early in training, this noise helps explore the parameter space, allowing the optimizer to break out of flat regions of the energy/loss landscape. As T decreases, the noise diminishes, making the updates more deterministic and focused on fine-tuning the parameters. The soft quantization operator S(⋅) projects the updated parameter onto discrete states, ensuring stable and controlled convergence. This approach balances exploration and exploitation, leading to precise optimization as training progresses. The acceptance function A(θᵢ, θⱼ, T) is a sigmoidal function of the energy difference between the current state θᵢ and the proposed state θⱼ:

$$A ( {θ}_{i} , {θ}_{j} , T ) = \frac{1}{1 + exp ( \frac{E ( {θ}_{j} ) - E ( {θ}_{i} )}{T} )} .$$

This acceptance criterion ensures that the move is more likely to be accepted if the energy (loss) at the proposed state θⱼ is lower than at θᵢ. If the energy at θⱼ is higher, the move is accepted with a probability that decreases with both the energy difference and the temperature.

The practical design of soft quantization can be rewritten in Gibbs form, S(θᵢ)= [symbol] q πᵢ(q)∝exp[−Eᵢ(q)/T], Eᵢ(q)=|θᵢ−q|, revealing that soft quantization is thermodynamically equivalent to a Boltzmann sampler over a discrete surrogate energy Eᵢ(⋅). Its contribution is two-fold:
(i) Stability & implicit regularization. The projection S(θᵢ) contracts the update θᵢ←θᵢ−ημᵢ+ϵ(T)= [symbol] onto a convex hull of Q, preventing large jumps in high-curvature regions and acting as a temperature controlled weight decay.
(ii) Exploration. At high T each πᵢ(q)≈1/| [symbol] |, recovering the “trivial state” required by Theorem 1 for broad search; as T↓ the distribution sharpens and the operator morphs into a hard nearest-neighbour projection, thus turning stochastic search into deterministic finetuning (Theorem 2).

Let σᵢₙᵢₜ denote the standard deviation of the parameter initialization distribution (e.g. Kaiming). Chosen is [symbol] ={m·Δ|m=−(K−1)/2, . . . , (K−1)/2}, Δ=κσᵢₙᵢₜ, with an odd K so that 0∈ [symbol] . Empirically, κ∈[0.5, 1] keeps ma [symbol] |θᵢ−q| within one standard-deviation of typical weights, ensuring that (i) the high-T uniform condition of Theorem 1 is satisfied, and (ii) gradients remain well scaled after quantization. In practice, K=256 can be used for small/medium networks and K=1024 for large-scale ImageNet/Kinetics runs; this disclosure proves that larger K does not harm convergence but brings diminishing returns once K>256.

DF-GDA proposes adjusting the temperature dynamically based on the total entropy of the parameter space. The entropy H(θ) at iteration t is defined as:

$$H ( {θ}^{( t )} ) = - {Σ}_{i = 1}^{n} {Σ}_{k = 1}^{K} P ( {θ}_{i} = {q}_{k} ) log P ( {θ}_{i} = {q}_{k} )$$

where P(θᵢ=qₖ) is the probability of parameter θᵢ being in the quantized state qₖ, given by the soft quantization function.

The temperature is updated based on the ratio of the current entropy to the maximum entropy:

$$T ( t + 1 ) = {T}_{max} \cdot \frac{H ( {θ}^{( t + 1 )} )}{{H}_{max}}$$

where Hₘₐₓ is the maximum entropy observed early in training, and Tₘₐₓ is the initial temperature. This ensures that as the entropy decreases (i.e., the model becomes more confident), the temperature decreases, transitioning the optimization from exploration to exploitation.

At high initial temperatures T₀, the soft quantization function assigns equal (uniform) probabilities to all K quantized states, i.e.,

$$S ( {θ}_{i} ) \approx \frac{1}{k}$$

for all k. This occurs as the exponential in the probability function flattens, ensuring broad exploration and preventing premature convergence. As T decreases, the function shifts to favor optimal states, balancing exploration and exploitation.

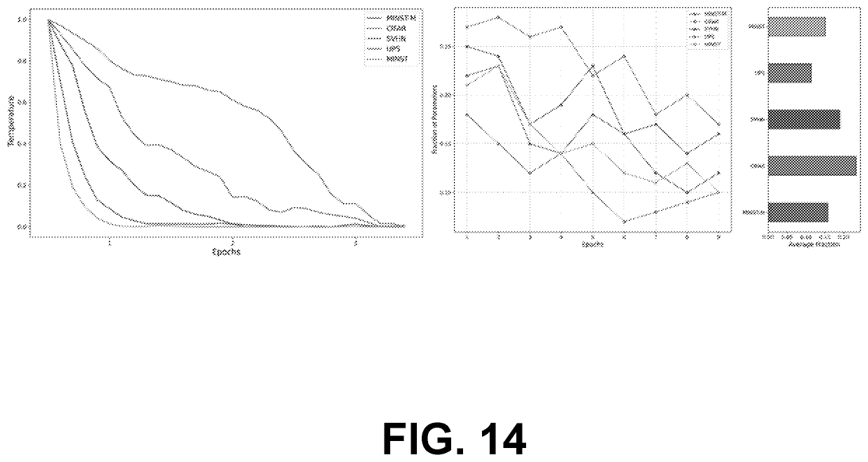

The temperature is controlled through the empirical entropy of the soft quantization weights, yielding a single-line update. This entropy-controlled schedule (i) satisfies the monotone cooling assumptions of Theorems 1-2, (ii) adapts automatically to model size and task difficulty without extra hyper-parameters, and (iii) reduces to deterministic nearest-neighbor projection once Tₜ≤Tₘᵢₙ=0.01 Tₘₐₓ, at which point each Tu; is >0.98 concentrated on its mode. FIG. 14 (left) illustrates a typical trajectory, showing rapid early exploration followed by smooth convergence. At iteration 0 the entropy H₀ is maximal, so T₀=Tₘₐₓ enables large stochastic moves that explore multiple basins of the loss surface. As training proceeds Hₜ shrinks, and the schedule Tₜ₊₁=Tₘₐₓ Hₜ/log | [symbol] | cools proportionally, progressively sharpening the landscape until Tₜ≤Tₘᵢₙ=0.01 Tₘₐₓ, where DF-GDA behaves as a deterministic fine tuner. Thus, a single parameter, Tₘₐₓ, self-balances global exploration and local refinement without manual tuning.

The entropy-controlled temperature schedule provides three main advantages over a standard geometric schedule: it is hyper-parameter-free and automatically adapts to model size and task difficulty, it monotonically cools in a way that preserves the convergence guarantees of DF-GDA, and it accelerates training by spending more of the optimization budget in a low-temperature, deterministic fine-tuning phase. Its chief trade-offs are a modest (≈3%) computational overhead for entropy computation and a potential sensitivity to rare plateaus where entropy drops prematurely—mitigated in practice by clamping the temperature at Tₘᵢₙ=0.01 Tₘₐₓ. Overall, the adaptive schedule's gains in convergence speed, accuracy, and noise robustness outweighs these minor costs, making it a sensible default for DF-GDA.

Traditional optimization methods, such as SA or GD, which update all parameters at each iteration, suffer from high computational costs and inefficiency when scaling to large models. Meanwhile, GDA updates one parameter per iteration, which leads to slow convergence. To address these limitations, this disclosure proposes the dynamic fractional parameter update framework, which dynamically adjusts the fraction of parameters updated at each iteration. This fraction is controlled based on the loss dynamics, allowing for more efficient updates while maintaining the exploratory benefits of annealing.

Rather than updating all parameters at each iteration, DF-GDA updates a fraction ƒ(t) of the parameters, where ƒ(t) is dynamically adjusted based on the recent changes in the loss function. The fraction is defined as:

$$f ( t ) = {f}_{min} + ( {f}_{max} - {f}_{min} ) \cdot exp ( - \frac{Δ L ( C )}{max ( Δ L )} )$$

where ƒₘᵢₙ and ƒₘₐₓ are the minimum and maximum fractions of parameters to be updated, respectively. ΔL(t)=|L(t)−L(t−1)| is the change in the loss between consecutive iterations. Additionally, max(ΔL) is the maximum observed loss change used for normalization. This ensures that a larger fraction of parameters is updated early in training when loss changes are significant. As the loss stabilizes, fewer parameters are updated, encouraging fine-tuning in the later optimization stages.

Furthermore, DF-GDA incorporates a blockwise fractional sampling strategy for parameters, where each training iteration operates on a block of the parameters, ensuring that all parameters are updated by the end of each epoch. In the blockwise fractional approach, the model's parameters set θ is divided into B non-overlapping blocks θ={Θ₁, Θ₂, . . . , Θ_{B}}, where each block Θ_{b} contains a fraction of the total samples. At each iteration t, one block of parameters Θ_{b} is updated during training, and by the end of each training epoch, all the blocks are updated, ensuring that all parameters are covered. This approach reduces the computational load per iteration and increases memory efficiency.

Let B=[1/ƒₘᵢₙ] and Θ={Θ₁, . . . , Θ_{B}} be a size-balanced, nonoverlapping partition of the parameter vector obtained by greedily accumulating tensors until each block reaches [∥θ∥/B] scalars (large kernels are split along the channel axis when needed). At every iteration, updated is the single block whose index πₜ(b) is drawn from afresh random permutation πₜ generated at the beginning of the current epoch; hence every parameter is visited exactly once per epoch and with probability ƒ(t) at step t. This schedule preserves the unbiasedness of the stochastic gradient and satisfies the sufficient-descent condition of Theorem 3, and, by keeping one block resident in GPU memory, reduces the per-step complexity of DF-GDA to [symbol] (ƒ(t)nK) without altering its convergence guarantee.

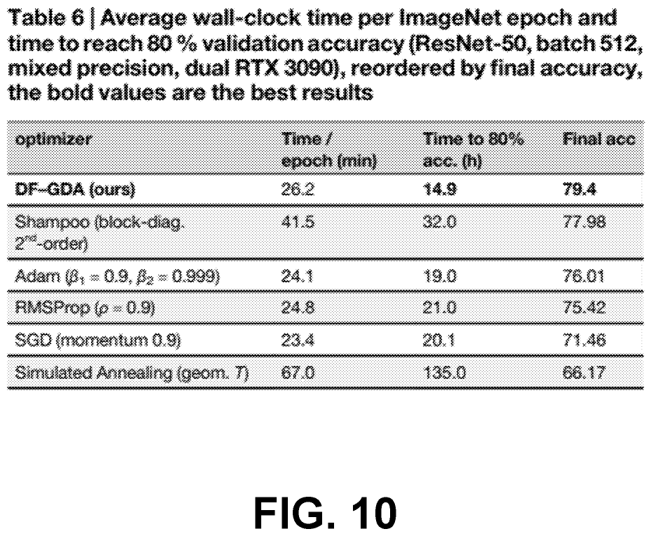

DF-GDA can be endowed with a time-varying update rate: at the start of training the loss drops sharply, so ƒ(t)≈ƒₘₐₓ=0.5 and 50% of the parameters follow the gradient each step, yielding fast descent. As soon as ΔL(t) falls below 1% of its initial value, ƒ(t) contracts exponentially towards ƒₘᵢₙ=0.01, leaving a 1% subset to be fine-tuned. Combined with the block-wise schedule, this shrinks the per-step cost to [symbol] (ƒ(t)nk) and is the main reason DF-GDA reaches the 80% ImageNet milestone sooner than strong first-order baselines (see table 6 in FIG. 10 and the discussion following Theorem 3).

Let n be the number of trainable parameters, K the number of soft quantization states (a small constant; K=512 in all experiments), and ƒ(t)∈(0,1] the dynamically chosen update fraction at iteration t with k(t)=└ƒ(t)n┘.

Each training step consists of the usual back-propagation ( [symbol] (backprop)) and an annealing overhead unique to DF-GDA:

$${T}_{D F - G D A} ( t ) = k ( t ) {\underbrace{𝒪 ( K )}}_{soft - quantization + acceptance test} 𝒪 ( f ( t ) nK ) .$$

The worst case is (ƒ(t)=1, first few epochs): [symbol] (nK). Typical/late training is (ƒ(t)→0.02): [symbol] (0.02 nK), yielding a >50×speed-up over classical SA that updates all parameters throughout. DF-GDA stores (i) the parameter vector θ∈ [symbol] ⁿ, (ii) a same-size running mean μ, and (iii) one scratch vector of length K reused across parameters.

$$Hence {S}_{D F - G D A} : {\underbrace{𝒪 ( n )}}_{θ , μ} + {\underbrace{𝒪 ( K )}}_{scratch} = 𝒪 ( n ) ( K ≪ n ) .$$

Classical SA implementations that cache a full probability matrix incur [symbol] (nK) memory, while adaptive optimizers such as Adam require an extra [symbol] (n) variance buffer-placing DF-GDA among the most memory-efficient choices.

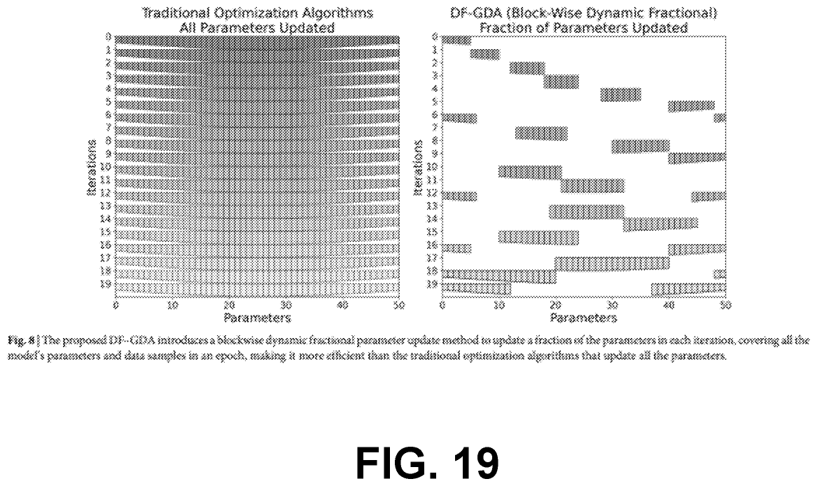

The analysis above, along with FIG. 19, demonstrates that DF-GDA achieves linear time and memory scaling in the model size, making it suitable for modern, large-scale deep networks. Classical simulated annealing proposes one neighboring state at every step; exploring the K×N configuration graph of a modern network therefore requires [symbol] ((KN)²) moves.

This stochastic walk can be transformed into a deterministic probability flow: all K states of each neuron are updated simultaneously, shrinking the search to [symbol] (K) operations per parameter and reducing the overall annealing pass to [symbol] (KN). Coupled with the fractional-update rule, the complexity becomes [symbol] (ƒ(t)nK), giving DF-GDA the same asymptotic cost as first-order optimizers while preserving the ability to escape poor basins.

Algorithm 1 summarizes the proposed DF-GDA, including all the steps discussed so far in the paper.

### Algorithm 1. DF-GDA Algorithm

### Require:

Initial parameters θ∈ [symbol] ⁿ, dataset [symbol] , initial temperature Tₘₐₓ, minimum and maximum fraction ƒₘᵢₙ, ƒₘₐₓ, sensitivity factor α, learning rate η, regularization parameter λ, and maximum number of iterations N.

```
Initialize mean field derivatives μᵢ = 0 for all i = 1, 2, ... , n
Set initial temperature T ← Tₘₐₓ
Set maximum entropy Hₘₐₓ based on the initial state distribution
Divide parameters θ into B blocks {θ₁, θ₂, ... , θ_{B}}
for each epoch e = 1, 2, ... , E do
  Shuffle dataset D and divide into B blocks
  for each block [symbol] _{b} ∈ D do
    Compute current loss [symbol]  (θ) on block [symbol] _{b}
    Compute change in loss ΔL = | [symbol]  (θ) − [symbol]  (θ)|
    Compute dynamic fraction f(t) as: f(t) = fₘᵢₙ + (fₘₐₓ − fₘᵢₙ) ·
exp (−ΔL/max(Δ(L)))
    Determine number of parameters to update k = └f(t) · n┘
    Select new k(t) parameters from θ for the current iteration to
update
    for each selected parameter θⱼ ∈ θᵢ do
      Update mean field derivatives: μᵢ ← μᵢ + (1 − α)∇ [symbol]  (θᵢ)
      $Propose new parameter {θ}_{i}^{′} using mean field update and$
$noise : {θ}_{i}^{′} = {θ}_{i} - η {μ}_{i} + ϵ ( T ) * 𝒩 ( 0 , I )$
      $Apply soft quantization : {θ}_{i}^{′} = {\sum }_{k = 1}^{K} {q}_{k} \cdot \frac{exp ( - \vert {θ}_{i}^{′} - {q}_{k} \vert / {T}_{q} )}{{\sum }_{j = 1}^{K} exp ( - \vert {θ}_{i}^{′} - {q}_{j} \vert / {T}_{q} )}$
      Compute energy difference ΔE = E(θ′ᵢ) - E(θᵢ)
      $Compute acceptance probability : {P}_{accept} = \frac{1}{1 + exp ( Δ E / T )}$
      $if rand ( 0 , 1 ) < A ( {θ}_{j} , {θ}_{j}^{′} , T ) ; then$
        $Accept new state : {θ}_{j}^{( t + 1 )} ← {θ}_{j}^{′}$
      else
        $Reject new state : {θ}_{j}^{( t + 1 )} ← {θ}_{j}^{( t )}$
      end if
    end for
    $Compute current entropy H ( θ ) : H ( θ ) = - {\sum }_{i = 1}^{n} {\sum }_{k = 1}^{K} P ( {θ}_{1} = {q}_{k} ) log P ( {θ}_{i} = {q}_{k} )$
    Update temperature using total entropy: T ← Tₘₐₓ · H(θ)/Hₘₐₓ
  end for
end for
Output: optimized parameters θ
```

Optimization of SVMs using DF-GDA The proposed DF-GDA is not limited to deep-learning models: Its temperature-controlled fractional updates, coupled with logarithmic barrier terms and the joint annealing of model hyperparameters, make it a powerful drop-in optimizer for constrained classical learners such as soft-margin SVMs and even unconstrained objectives like k-means. The SVM study illustrates this capability, achieving grid-search-free optimization with strict feasibility guarantees and faster convergence.

Given labeled samples

$${\{ ( {x}_{i} , {y}_{i} ) \}}_{i = 1}^{N}$$

with yᵢ∈{±1}, the soft-margin SVM seeks

$$\begin{matrix}min \\ w ; b ; ξ\end{matrix} \frac{1}{2} \vert \vert w {\vert \vert}_{2}^{2} + C {\sum }_{i = 1}^{N} {ξ}_{i} s . t . {y}_{i} ( {w}^{⊤} ϕ ( {x}_{i} ) + b ) \geq 1 - {ξ}_{i} , {ξ}_{i} \geq 0 , ( 16 )$$

where φ(⋅) is an implicit feature map induced by the kernel k(xᵢ, xⱼ)=φ(xᵢ)^{T}φ(xⱼ). Incorporated are the box constraints 0≤ξᵢ and the margin constraints yᵢ(w^{T}φ(xᵢ)+b)≥1−ξᵢ exactly—rather than heuristically as in the previous draft—using a quadratic barrier:

$${ℰ}_{𝒫} ( θ , T ) = \frac{1}{2} \vert \vert w {\vert \vert}_{2}^{2} + C {Σ}_{i} {ξ}_{i} - \frac{T}{2} {Σ}_{i} [ log ( 1 - {ξ}_{i} ) + log ( {y}_{i} ( {W}^{⊤} ϕ ( {x}_{i} ) + b ) - 1 + {ξ}_{i} ) ] ,$$

where θ=(w, b, ξ) and T is the DF-GDA temperature.

The logarithmic barrier guarantees feasibility throughout annealing; as T↓0, the barrier vanishes and is recovered. Introducing Lagrange multipliers α∈[0, C]^{N} and eliminating (w, b, ξ) yields the dual energy

$${ℰ}_{D} ( α , γ , T ) = - {1}^{⊤} α + \frac{1}{2} {α}^{⊤} Q ( γ ) α - \frac{T}{2} {Σ}_{i} [ log ( {α}_{i} ) + log ( C - {α}_{i} ) ] ,$$

$$with {Q}_{i j} ( γ ) = {γ}_{i} {γ}_{j} exp ( - γ \vert \vert {x}_{i} = {x}_{j} {\vert \vert}_{2}^{2} )$$

for the RBF kernel. DF-GDA updates a fraction ƒ(t) of the αᵢ, projects them via soft quantization onto [0, C], and anneals T according to the schedule in of DF-GDA. The barrier terms are rigorously maintained the box constraints 0≤αᵢ≤C throughout optimization.

Kernel width is tuned inside DF-GDA by treating y as an additional scalar parameter and appending a smooth [symbol] ₂-regulariser λ_{γ}(γ−γ₀)². The same fractional-update rule applies, enabling a temperature-controlled exploration-exploitation trade-off over γ. This removes the need for grid search and directly.

Enhanced K-means clustering using DF-GDA To optimize the k-means clustering process and enhance its performance, particularly in terms of convergence and robustness against local optima, the principles of DF-GDA can be incorporated.

Classical k-means clustering aims to partition n observations into k clusters where each observation belongs to the cluster with the nearest mean. The objective is traditionally formulated as: min

$${Σ}_{i = 1}^{k} {Σ}_{x ∈ {S}_{i}} \vert \vert x - {μ}_{i} {\vert \vert}^{2}$$

where Sᵢ represents the set of points in cluster i and μᵢ is the centroid of points in Sᵢ.

To incorporate DF-GDA principles, the objective function is modified to include a temperature-controlled energy component:

$$E ( μ , T ) = {Σ}_{i = 1}^{k} {Σ}_{x ∈ {S}_{i}} \vert \vert x - {μ}_{i}^{′} {\vert \vert}^{2} + \frac{λ}{T} {Σ}_{i = 1}^{k} \vert \vert {μ}_{i} - {μ}_{i}^{′} \vert \vert ,$$

where μ′ᵢ represents the potential new state for centroid μᵢ influenced by a soft quantization mechanism, and λ is a regularization parameter that helps control the updates' magnitude.

Centroids are updated by balancing the classical mean computation with a noise-injected term that promotes exploration:

$${μ}_{i}^{n e w} = \frac{1}{\vert {S}_{i} \vert} {Σ}_{x ∈ {S}_{i}} x - η \frac{δ E}{{δμ}_{i}} + ϵ ( T ) .$$

N(0, σ²), where η denotes the learning rate, ϵ(T) is a temperature-dependent term introducing Gaussian noise N(0, σ²), encouraging the exploration of new cluster configurations.

In this section, the theoretical foundations of the DF-GDA algorithm are presented. The theoretical foundation of the disclosure presents key contributions, including a theorem on initial temperature settings to ensure broad exploration and prevent local minima entrapment. It rigorously demonstrates convergence properties, showing the algorithm's shift from stochastic to deterministic updates for stable optimization. The dynamic fractional update mechanism and soft quantization are analyzed for their adaptability and stability, ensuring controlled parameter updates. Moreover, the expected convergence time is quantified, providing bounds on performance.

Theorem 1: Initial Temperature for DF-GDA Statement: For the DF-GDA algorithm to explore the parameter space broadly at initiation, the initial temperature T₀ must be chosen sufficiently high. In particular, given any tolerance ϵ∈(0,1), required is

$${T}_{0} \geq \frac{{max}_{i} Δ E ( {θ}_{i} )}{K ϵ} ,$$

where ΔE(θᵢ) denotes the maximum energy difference between any two quantized states for parameter θᵢ (defined precisely below) and K is the number of quantized states. Under this condition, the soft quantization distribution for each parameter θᵢ at T₀ is approximately uniform across the K states (the so-called “trivial state” in annealing theory), meaning that each state qₖ is assigned a probability of approximately 1/K (within ϵ of 1/K). This ensures a broad exploration of the parameter space at the start of training.

Proof. Let θ=(θ₁, θ₂, . . . , θₙ)∈ [symbol] ⁿ be the set of model parameters, and for each parameter θᵢ, let {q₁, q₂, . . . , q_{K}} be the K possible quantized states. The DF-GDA algorithm employs a soft quantization function to assign each θᵢ a probability distribution over these K states. Specifically, for a given temperature T, the probability of θᵢ being in state qₖ is

$${P}_{i , k} ( T ) = \frac{exp ( - \frac{\vert {θ}_{i -} {q}_{k} \vert}{T} )}{{Σ}_{j = 1}^{K} exp ( - \frac{\vert {θ}_{i -} {q}_{j} \vert}{T} )} ,$$

and the soft-quantized value S(θᵢ) is the expectation

$$S ( {θ}_{i} ) = {Σ}_{k = 1}^{K} {q}_{k} {P}_{i , k} ( T ) .$$

To guarantee broad exploration at initialization, P_{i,k}(T₀)≈1/K should be true for all i and all k∈{1, . . . , K}; in other words, the distribution Pᵢ,⋅(T₀) should be nearly uniform on the K states.

Uniformity of the probabilities P_{i,k}(T₀) occurs when all the exponential terms exp(−|θᵢ−qₖ|/T₀) are nearly equal for k=1, . . . , K. This requires T₀ to be large enough that differences in the “energy” |θᵢ−qₖ| have negligible effect. Equivalently, for any two states qₖ and qⱼ,

$$exp ( - \frac{\vert {θ}_{i} - {q}_{k} \vert}{{T}_{0}} ) \approx exp ( - \frac{\vert {θ}_{i} - {q}_{j} \vert}{{T}_{0}} ) ∀ k ,$$

j should be true. Canceling the common factor of 1/T₀ in the exponents, the stated condition is approximately satisfied when |θᵢ−qₖ|≈|θᵢ−qⱼ| for all k, j. In practice, it suffices that T₀ be large enough to dampen the influence of any differences in |θᵢ−qₖ|. Now, define ΔE(θᵢ) as the maximum difference in energy or loss (here, energy is measured by the absolute distance to a state) between any two quantized states for θᵢ.

$$ΔE ( {θ}_{i} ) = {1 \leq k ; j \leq K}^{max} \vert \vert {θ}_{i} - {q}_{k} \vert - \vert {θ}_{i} - {q}_{j} \vert \vert .$$

In words, ΔE(θᵢ) is the largest gap between the distances of θᵢ to any two quantization levels. Intuitively, if T₀ is on the order of or larger than this maximum gap (scaled appropriately by K and ϵ as below), then even the largest energy difference between states will be smoothed out by the soft max function. To achieve an ϵ-close to uniform distribution, the condition on T₀ is derived. It is required that no state qₖ for parameter θᵢ has probability deviating from 1/K by more than ϵ. Formally, for each θᵢ and each 1≤k≤K, it is desired for

$$\vert {P}_{i , k} {T}_{0} - \frac{1}{K} \vert \leq ϵ$$

to be true. The stated lower bound on T₀ guarantees this condition, as will be shown.

First, observe that for any fixed θᵢ, the ratio between the largest and smallest softmax weight is bounded by the exponential of the maximum energy difference:

$$\frac{{max}_{1 \leq k \leq K} exp ( - \vert {θ}_{i} - {q}_{k} \vert / {T}_{0} )}{{min}_{1 \leq k \leq K} exp ( - \vert {θ}_{i} - {q}_{k} \vert / {T}_{0} )} = exp ( \frac{{max}_{k , j} ‖ {θ}_{i} - {q}_{k} \vert - \vert {θ}_{i} - {q}_{j} ‖}{{T}_{0}} ) = exp ( \frac{Δ E ( {θ}_{i} )}{{T}_{0}} )$$

If T₀ satisfies

$${T}_{0} \geq \frac{Δ E ( {θ}_{i} )}{K ϵ}$$

for this parameter θᵢ, then

$$exp ( \frac{Δ ( {θ}_{i} )}{{T}_{0}} ) \leq exp ( K ϵ ) .$$

This means that all the exponential terms exp(−|θᵢ−qₖ|/T₀) differ from each other by at most a factor of e^{Kϵ}. In particular, the largest weight is at most e^{Kϵ} times the smallest weight. As a result, the softmax probabilities P_{i,k}(T₀) cannot stray too far from equal shares. In fact, using the above ratio bound, one can show:

$$\frac{1}{K {e}^{K ϵ}} \leq {P}_{i , k} ( {T}_{0} ) \leq \frac{{e}^{K ϵ}}{K}$$

for each state k. Subtracting 1/K and taking absolute values,

$$\vert {P}_{i , k} ( {T}_{0} ) - \frac{1}{K} \vert \leq \frac{{e}^{K ϵ} - 1}{K}$$

is obtained. For sufficiently small values of ϵ, the inequality e^{Kϵ}−1<Kϵe^{Kϵ} can be used, which implies

$$\frac{{e}^{K ϵ} - 1}{K} < ϵ {e}^{K ϵ} \approx ϵ ( since {e}^{K ϵ} \approx 1$$

for small K_{ϵ}). Thus, the deviation bound is satisfied. In simpler terms, when T₀ is at least

$$\frac{\begin{matrix}max \\ i\end{matrix} Δ ( {θ}_{i} )}{K ϵ} ,$$

the initial probability assigned to each state qₖ differs from 1/K by at most an order-ϵ quantity. This confirms that the distribution Pᵢ,⋅(T₀) is nearly uniform over the K states, as required for broad exploration.

Theorem 2. Final Temperature for DF-GDA Statement: The final annealing temperature T_{ƒ} must be set sufficiently low to ensure that the dynamic fractional updates converge each parameter to a stable quantized state and to prevent oscillations among states. In effect, as the temperature T approaches T_{ƒ}, the parameter updates become so small that the system stabilizes in (at least) a locally optimal configuration of the parameters.

Formally, let

$${q}_{{k}_{o p t}}^{( i )}$$

be the quantized state of parameter θᵢ that minimizes the energy E(θᵢ) (i.e., the lowest-energy state for θi). Define the minimum energy gap for θᵢ as

$$Δ E ( {θ}_{i} ) = \begin{matrix}min \\ k \neq {k}_{opt}^{( i )}\end{matrix} ( E ( {q}_{k} ) - E ( {q}_{{k}_{o p t}}^{( i )} ) ) ,$$

which (since E(q)=|θᵢ−q| in this disclosure's formulation) can be written as

$${min}_{k \neq {k}_{o p t}^{( i )}} ( \vert {θ}_{i} - {q}_{k} \vert - \vert {θ}_{i} - {q}_{{k}_{o p t}}^{( i )} \vert ) .$$

To guarantee convergence, choose T_{ƒ} such that

$${T}_{f} \leq \frac{{min}_{i} Δ E ( {θ}_{i} )}{K ln \frac{1}{ϵ}} ,$$

for some small convergence threshold ϵ>0. Under this condition, for each parameter θᵢ the probability of θᵢ transitioning to any suboptimal state

$${q}_{k} \neq {q}_{{k}_{o p t}}^{( i )}$$

is at most ϵ. Equivalently, each θᵢ remains (with probability at least 1−ϵ) in its optimal quantized state

$${q}_{{k}_{o p t}}^{( i )} as T \to {T}_{f} .$$

This ensures that the fractional updates have effectively converged (further updates result in negligible changes), and the system is locked into a stable configuration.

Proof. Consider the DF-GDA update process for a given parameter θᵢ with K possible quantized states. As training progresses and the temperature T is lowered, the soft quantization distribution P_{i,k}(T) gains density for the lowest-energy state

$${q}_{{k}_{o p t}}^{( i )} .$$

At high temperatures, all states are nearly equally likely (as shown by Theorem 1), allowing broad exploration. In contrast, at low temperatures, the softmax heavily favors the minimum-energy (optimal) state. Mathematically, as T decreases toward T_{ƒ}, P_{i,k}_{ₒₚₜ}(T_{ƒ})≈1 and P_{i,k}(T_{ƒ})≈0 for any k≠kₒₚₜ is desirable.

To quantify this, let

$${q}_{{k}_{o p t}}^{( i )}$$

be the optimal state for θᵢ

$$( so E ( {q}_{{k}_{opt}}^{( i )} )$$

is minimal). For any other state

$${q}_{k} ( k \neq {k}_{opt}^{( i )} ) ,$$

the ratio of probabilities between the optimal state and qₖ at temperature T_{ƒ} is:

$$\frac{{P}_{i , {k}_{opt}} ( {T}_{f} )}{{P}_{i , k} ( {T}_{f} )} = \frac{exp ( - \vert {θ}_{i} - {q}_{{k}_{opt}} \vert / {T}_{f} )}{exp ( - \vert {θ}_{i} - {q}_{k} \vert / {T}_{f} )} = exp ( \frac{\vert {θ}_{i - {q}_{k}} \vert - \vert {θ}_{i - {q}_{{k}_{opt}}} \vert}{{T}_{f}} ) .$$

Let

$${δ}_{ik} = \vert {θ}_{i} - {q}_{k} \vert - \vert {θ}_{i} - {q}_{{k}_{opt}}^{( i )} \vert$$

denote the energy difference between state qₖ and the optimal state for θᵢ. The above ratio becomes exp(δᵢₖ=T_{ƒ}). For convergence, this ratio is required to be very large for every k≠kₒₚₜ, meaning exp(δᵢₖ/T_{ƒ})>>1. Equivalently,

$$exp ( \frac{{δ}_{ik}}{{T}_{f}} ) \geq \frac{1}{ϵ}$$

should be true for all k≠kₒₚₜ, where ϵ is a small desired upper bound on the probability of any suboptimal state. Inequality is satisfied if

$$\frac{{δ}_{ik}}{{T}_{f}} \geq ln \frac{1}{ϵ} for all k \neq {k}_{opt}^{( i )} ,$$

or equivalently T_{ƒ}≤δᵢₖ/ln(1/ϵ) for every k≠kₒₚₜ.

Taking the most restrictive of these (the smallest δᵢₖ),

$${T}_{f} \leq \frac{{min}_{k \neq {k}_{opt}^{( i )}} {δ}_{ik}}{ln ( 1 / ϵ )} = \frac{Δ E ( {θ}_{i} )}{ln ( 1 / ϵ )}$$

is obtained. The above must hold for each parameter θᵢ. To ensure all parameters meet the condition, a T_{ƒ} no greater than the minimum of the right-hand side across all i is chosen. Thus

$${T}_{f} \leq {min}_{i} \frac{Δ E ( {θ}_{i} )}{ln ( 1 / ϵ )} .$$

In practice, to incorporate the effect of having K states (and thus K−1 possible suboptimal transitions for each parameter), a conservative choice is to include the factor K in the denominator (distributing the ϵ tolerance across K possibilities), yielding the stated condition

$${T}_{f} \leq \frac{{min}_{i} Δ E ( {θ}_{i} )}{K ln ( 1 / ϵ )} .$$

(This ensures the probability of any suboptimal transitions among K states stays below ϵ.) Under this condition, the softmax probabilities at T_{ƒ} are heavily skewed to the optimal state. In particular, from there is P_{i;k}≤ϵP_{i;k}_{ₒₚₜ} for every k≠kₒₚₜ. Summing over all k≠kₒₚₜ gives Σ_{k≠k}_{ₒₚₜ} P_{i,k}(T_{ƒ})≤ϵΣₖ₊ₖ_{ₒₚₜ} P_{i,k}_{ₒₚₜ}(T_{ƒ})=ϵ(K−1)P_{i,k}_{ₒₚₜ}(T_{ƒ}).

Since P_{i,k}_{ₒₚₜ}+Σ_{k≠k}_{ₒₚₜ} P_{i,k}=1, the above implies

$${P}_{i , {k}_{opt}} ( {T}_{f} ) \geq \frac{1}{1 + ϵ ( K - 1 )} .$$

For small ϵ, P_{i,k}_{ₒₚₜ}(T_{ƒ})≈1/(1+something small), so indeed P_{i,k}_{ₒₚₜ}≈1. For example, if ϵ=0.05 and K=10, then P_{i,k}_{ₒₚₜ}(T_{ƒ})≥1/(1+0.45)≈0.69; if ϵ=0.01, this lower bound becomes ≈0.91.

In practice P_{i,k}_{ₒₚₜ} will be higher because the chosen T_{ƒ} is very conservative. Thus, is can safely be said that P_{i,k}_{ₒₚₜ}(T_{ƒ})≥1−ϵ and each suboptimal state qₖ has

$${P}_{i , k} ( {T}_{f} ) ≲ \frac{ϵ}{K - 1}$$

(approximately, assuming the ϵ probability mass is distributed among the K−1 suboptimal states). In other words, the probability of any parameter being in a non-optimal state is at most e, which means the system effectively stays in the optimal state configuration with high probability.

This condition prevents oscillations: once a parameter has settled into its optimal state, the chance of jumping out of it is negligible. As a result, as T→T_{ƒ}, the soft quantization distribution for each θᵢ becomes sharply peaked at

$${q}_{{k}_{opt}}^{( i )} .$$

The algorithm updates to θᵢ will then reinforce staying at

$${q}_{{k}_{opt}}^{( i )}$$

(since that state minimizes energy), and transitions to any other state are exceedingly unlikely. Therefore, the dynamic fractional updates stabilize—further adjustments to θᵢ (or to the fraction of parameters being updated) are vanishingly small. The DF-GDA system has effectively converged to a local optimum, with each parameter trapped in (or very close to) its lowest-energy quantized state.

Theorem 3. Convergence of Dynamic Fractional Updates Statement: The dynamic fractional update mechanism in DF-GDA guarantees that the optimization converges to a stable solution as the annealing temperature T is lowered. In particular, the fraction ƒ(t) of parameters updated at iteration twill decrease to its minimum allowed value ƒₘᵢₙ as T→T_{ƒ}, and the parameter updates themselves diminish in magnitude. Formally, one obtains

$${lim}_{T \to {T}_{f}} f ( t ) = {f}_{min} ,$$

ensuring that as the system cools to the final temperature, the minimum fraction of parameters is being updated, and these updates produce negligible changes. Consequently, the parameters θ settle into a (locally) optimal configuration, n and further training iterations do not significantly alter the loss L(θ).

Proof. The behavior of DF-GDA can be considered in terms of the training loss L(θ) and the dynamic update fraction ƒ(t). By design, DF-GDA adjusts the fraction of parameters to update based on the change in loss between iterations. Let ΔL(t)=L(θₜ₋₁)−L(θₜ) denote the decrease in loss at iteration t (it is assumed that L(θ) decreases as training progresses). The update fraction ƒ(t) is defined between a minimum value ƒₘᵢₙ and a maximum value ƒₘₐₓ, and is higher when the loss is changing rapidly, and lower when the loss change is small. A typical update rule (as used in this implementation) is:

$$f ( t ) = {f}_{min} + ( {f}_{max} - {f}_{min} ) exp ( - \frac{Δ L ( t )}{max ( Δ L )} ) .$$

Here, max(ΔL) is a normalization factor (e.g., the initial loss drop) that renders the exponent dimensionless. This rule means that when ΔL(t) is large, the term exp(ΔL(t)/max(ΔL)) is close to 0, so ƒ(t)≈ƒₘₐₓ; conversely, as ΔL(t)→0 (loss stabilizes), exp(−ΔL(t)/max(ΔL))→1, so ƒ(t)→ƒₘᵢₙ. In the early stages of training, when the loss is high and dropping quickly, one updates a large fraction of parameters (ƒ(t) near ƒₘₐₓ) to explore the parameter space aggressively. In later stages, as the loss plateaus, ƒ(t) decays toward ƒₘᵢₙ, meaning a small fraction of parameters are updated (promoting fine-tuning around the current solution). This dynamic scheduling of ƒ(t) balances exploration and exploitation throughout training. As the temperature T decreases and approaches T_{ƒ}, the DF-GDA algorithm enters its final phase where ΔL(t) becomes very small (the loss is nearly converged). Substituting ΔL(t)≈0 into the update rule,

$$f ( t ) \approx {f}_{min} + ( {f}_{max} - {f}_{min} ) exp ( - \frac{0}{max ( Δ L )} ) = {f}_{min}$$

is obtained.

More rigorously, taking the limit yields

$$\begin{matrix}lim \\ Δ L ( t ) \to 0\end{matrix} f ( t ) = {f}_{min} ,$$

which is precisely lim_{T→}ƒ(t)=ƒₘᵢₙ since ΔL(t)→0 as T→T_{ƒ}. Shown here is that the fraction of parameters being actively updated vanishes down to the minimum allowed fraction ƒₘᵢₙ in the convergence regime. The reduction of ƒ(t) has a direct effect on the parameter update magnitudes. The update rule for the model parameters in DF-GDA can be written (approximately) as θₜ₊₁=θₜ−ηƒ(t)∇L(θₜ)+ϵ(T) [symbol] (0, I) where η>0 is the learning rate and ϵ(T) [symbol] (0, I) is a temperature-dependent Gaussian noise term (with mean 0 and covariance I) added to encourage exploration.

The effective learning rate for updating parameters is ηƒ(t), which decreases as ƒ(t) decreases. In early training, ƒ(t)≈ƒₘₐₓ, so the effective step size is ηƒₘₐₓ, allowing substantial moves in parameter space. But as ƒ(t)→ƒₘᵢₙ, the effective step size becomes ηƒₘᵢₙ, which is much smaller. Thus, in the later stages, the parameter updates θₜ₊₁−θₜ become very small, as ϵ(T) (the noise amplitude) is decreasing with T and goes to zero as T→T_{ƒ}. The combination of a vanishing update fraction and vanishing noise means that the parameters change minimally in each iteration near the end of training. To formalize the convergence, L(θ) can be viewed as a Lyapunov function for the DF-GDA dynamics.

The expected change in L from iteration t to t+1 can be estimated by ignoring the (vanishing) noise term in and using a first-order Taylor expansion of L: L(θₜ₊₁)−L(θₜ)≈−ηƒ(t)∥∇L(θₜ)∥²; since the first-order term is −ηƒ(t) ∇ L(θₜ). ∇L(θₜ)=−ηƒ(t)∥∇L(θₜ)∥² and higher-order terms are negligible for small updates. Because η>0 and ƒ(t)>0, L(θₜ+1)≤L(θₜ) is obtained, meaning the loss is non-increasing. Moreover, as t grows large, ƒ(t)=>ƒₘᵢₙ and (for a well-behaved loss)∥∇L(θt)∥→0, so the decrement −ηƒ(t)∥∇L(θₜ)∥²→0. In the limit t→∞ (which corresponds to T→T_{ƒ} in the annealing schedule), ΔL(t)→0 and ∇L(θₜ)→0 are obtained. In other words, the parameters et approach a stationary point of the loss. Since L(θ) is monotonically decreasing and bounded below (by 0, assuming a nonnegative loss), L(θₜ) converges to some L*≥0, and θₜ converges to a (local) minimiser of L. At this point, ƒ(t) has reached ƒₘᵢₙ and updates are effectively frozen (any remaining updates are tiny fluctuations around the optimum).

In summary, as the temperature is lowered and the dynamic update fraction decays, the DF-GDA algorithm transitions from updating a large subset of parameters with sizable steps to updating a small subset with infinitesimal steps. The model thus undergoes a smooth convergence: the loss stabilizes, parameter changes become negligible, and the algorithm settles into a stable solution. This analysis confirms that DF-GDA will converge to a local optimum of L(θ), with ƒ(t)→ƒₘᵢₙ and θₜ₊₁−θₜ→0 as t (and 1/T) approaches infinity.

Theorem 4. Expected Time to Convergence for DF-GDA Statement: Let L(θ) be a continuously differentiable loss function bounded below by Lₘᵢₙ, and consider the DF-GDA update θₜ₊₁=θₜ−ηƒ(t)∇L(θₜ)+ϵ(Tₜ) [symbol] (0, I); where 0<ƒ(t)≤1 is the fraction of parameters updated at iteration t, η>0 is the learning rate, and ε(Tₜ) [symbol] (0; I) is a zero-mean, Tₜ-dependent Gaussian perturbation. Define ΔLₜ:=L(θₜ+1)−L(θₜ) as the one-step change in the loss. Suppose there exists a constant μ>0 such that [symbol] [ΔLₜ]=−μ (i.e., the expected decrease in the loss per iteration is μ) and assume ƒ(t) is bounded below by a positive constant ƒₘᵢₙ>0 for all t. Then, the expected number of iterations τ required for DF-GDA to reach an ϵ-neighborhood of a local minimum (i.e., L(θ_{τ})≤Lₘᵢₙ+ϵ) satisfies

$$𝔼 [ τ ] \leq \frac{L ( {θ}_{0} ) - ( {L}_{min} + ϵ )}{μ {f}_{min}} .$$

In particular, for small ϵ, this implies

$$𝔼 [ τ ] \approx \frac{L ( {θ}_{0} ) - {L}_{min}}{μ {f}_{min}} ,$$

indicating linear expected convergence time proportional to the initial gap L(θ₀)−Lₘᵢₙ.

Proof. Under the stated assumptions, the expected change in loss at each iteration is at least μƒₘᵢₙ. Let us focus on the deterministic part of the update (ignoring the zero-mean noise). It can be written that θₜ₊₁≈θₜ−ηƒ(t)∇L(θₜ). For small η, a first-order Taylor expansion of L(θ) around θₜ gives L(θₜ₊₁)≈L(θₜ)+∇L(θₜ)(θₜ₊₁−θₜ)=L(θ)−ηƒ(t)∥∇L(θₜ)∥². Hence, ΔLₜ=L(θₜ₊₁)−L(θₜ)≈−ηƒ(t)∥∇L(θₜ)∥².

By assumption, [symbol] [ΔLₜ]=−μ for all t, so μ=− [symbol] [ΔLₜ]≈η\ mthbbE[ƒ(t)∥∇L(θₜ)∥²]. Since ƒ(t)≥ƒₘᵢₙ>0, it is true that ηƒ(t)∥∇L(θₜ)∥²≥ηƒₘᵢₙ∥∇L(θₜ)∥². Hence, the algorithm achieves an expected loss decrease of at least μƒₘᵢₙ per iteration. This decrease is summed over τ iterations:

$$𝔼 [ L ( {θ}_{0} ) = L ( {θ}_{τ} ) ] = {\sum }_{t = 0}^{r = 1} 𝔼 [ - Δ {L}_{t} ] = τ \cdot μ .$$

Since L(θ) is bounded below by Lₘᵢₙ, L(θ_{τ})≥Lₘᵢₙ is true for all τ. Thus, to ensure L(θₜ)≤Lₘᵢₙ+ϵ, required is that the expected total decrease exceed the initial gap minus ϵ: τ·μ≥L(θ₀)−(Lₘᵢₙ+ϵ). Solving for τ yields

$$τ \geq \frac{L ( θ ) - ( {L}_{min} + ϵ )}{μ} .$$

Because the fractional update ƒ(t)≥ƒₘᵢₙ>0 ensures at least that level of adjustment, the effective decrease per iteration meets or exceeds μƒₘᵢₙ. Hence, more precisely,

$$𝔼 [ τ ] \leq \frac{L ( {θ}_{0} ) - ( {L}_{min} + ϵ )}{μ {f}_{min}} :$$

In practice, μ may shrink near a fixed point, so the above yields a baseline complexity estimate in the region where ∥∇L(θₜ)∥ is still relatively large, demonstrating approximately linear convergence in expectation.

Theorem 5. Stability of Soft Quantization under Perturbations Statement: Let S(θᵢ) be the soft quantization function for parameter θᵢ, assigning probabilities to a set of discrete quantized levels q₁, . . . , q_{K} via

$$S ( {θ}_{i} ) = {\sum }_{k = 1}^{K} {q}_{k} \frac{exp ( - abs {θ}_{i} - {q}_{k} / T )}{{\sum }_{j = 1}^{K} exp ( - \vert {θ}_{i} - {q}_{j} \vert / T )} .$$

For any fixed temperature T>0 and any small perturbation δ of θᵢ, the change in S(θᵢ) is bounded by

$$‖ S ( {θ}_{i} + δ ) - S ( {θ}_{i} ) ‖ \leq C \vert δ \vert exp ( - \frac{\vert δ \vert}{T} ) ,$$

for some constant C>0 independent of δ. Consequently, the probability distribution for the quantized states is stable under bounded perturbations of θᵢ, preventing excessive oscillations.

Proof. Consider θᵢ [symbol] S(θᵢ) defined via a softmax-like function over the distance |θᵢ−qₖ|. Denote

$${P}_{k} ( {θ}_{i} ) = \frac{exp ( - \vert {θ}_{i} - {q}_{k} \vert / T )}{{\sum }_{j = k}^{K} exp ( - \vert {θ}_{i} - {q}_{j} \vert ) / T} .$$

### Thus

$$S ( {θ}_{i} ) = {\sum }_{k = 1}^{K} {q}_{k} {P}_{k} ( {θ}_{i} ) .$$

It can be analyzed how Pₖ(θᵢ) responds to a perturbation δ: Pₖ(θᵢ+δ)−Pₖ(θᵢ). By the mean value theorem, the difference in the numerator is approximately

$${\frac{\partial }{\partial {θ}_{i}} exp ( - \vert {θ}_{i} - {q}_{k} \vert / T ) \vert}_{δ} \times δ$$

for some \tilde{θ}ᵢ in [θᵢ, θᵢ+δ]. That partial derivative is bounded by

$$\frac{1}{T} Exp ( - \vert \tilde{{θ}_{ι}} - {q}_{k} \vert / T )$$

in magnitude. A similar statement holds for each term in the denominator. Collecting terms and simplifying, one finds that for an appropriate constant C, the final change satisfies |Pₖ(θᵢ+δ)−Pₖ(θᵢ)|≤C|δ|exp(−|θᵢ−qₖ|/T), where the fact can also be used that the set of exponential terms in the denominator sums to a normalizing factor near 1.

Because S(θᵢ+δ)−S(θᵢ) is a linear combination

$${\sum }_{k = 1}^{K} {q}_{k} [ {P}_{k} ( {θ}_{i} + δ ) - {P}_{k} ( {θ}_{i} ) ] ,$$

the same Lipschitz-like bound extends to S(θᵢ):

$$‖ S ( {θ}_{i} + δ ) - S ( {θ}_{i} ) ‖ \leq {\sum }_{k = 1}^{K} \vert {q}_{k} \vert \vert {P}_{k} ( {θ}_{i} + δ ) - {P}_{k} ( {θ}_{i} ) \vert .$$

Factoring out a maximum scale from {qₖ} if necessary, it can be absorbed into C and noted that exp(−|θᵢ−qₖ|/T) is bounded by exp(−|δ|/T) if |δ| is larger or on the order of |θᵢ−qₖ|.

Thus, it can be written that, for a suitable constant

$$C > 0 , ‖ S ( {θ}_{i} + δ ) - S ( {θ}_{i} ) ‖ \leq C \vert δ \vert exp ( - \frac{\vert δ \vert}{T} ) ;$$

which completes the proof. The key conclusion is that a bounded (and especially small) perturbation δ in θᵢ has a bounded, smoothly controlled effect on S(θᵢ), meaning soft quantization is stable in the presence of small parameter fluctuations.

Theorem 6. Convergence of Blockwise Updates & Lyapunov Stability Statement: Consider the DF-GDA algorithm with blockwise fractional parameter updates, and let the temperature T (t) be reduced according to an entropy-based schedule so that T(t)→0 as t→∞. Assume L(θ) is continuously differentiable and bounded below by Lₘᵢₙ.

Then: 1. All limit points of the parameter sequence {θₜ} are stationary points of L(θ) (i.e., ∇L(θ*)=0).

2. L(θᵢ)→L>Lₘᵢₙ, and if L is convex (or satisfies a suitable global condition), L* is the global minimum.

3. The final solution θ* is Lyapunov-stable: if θ is perturbed slightly near θ*, the DF-GDA update moves it back toward θ*, preventing large deviations or divergent behavior.

Proof. (1) Convergence to Stationary Points. Over one full epoch, each parameter block is updated exactly once (or at least once). In iteration t, let the subset of parameters being updated be [symbol] ₜ of size k(t)=└ƒ(t)·n┘. Neglecting the noise term (which vanishes as T→0), the update for any i∈ [symbol] ₜ reads:

$${θ}_{i}^{( t + 1 )} = {θ}_{i}^{( t )} - η {∇}_{{θ}_{i}} L ( {θ}^{( t )} )$$

soft quantization term:

Hence, when T is small, soft quantization S(⋅) behaves nearly as the identity. Over many epochs, each parameter is updated repeatedly, and the method approximates (blockwise) gradient descent. A standard analysis shows that block coordinate descent on a continuously differentiable, bounded-below function converges to a stationary point, provided the step size η is suitably small. Additionally, the noise vanishes and the fractional updates ƒ(t) eventually become small (but positive), thus the iteration is stable enough to ensure ∥∇L(θₜ)∥→0. Hence all accumulation points must satisfy ∇L(θ*)=0. Thus the sequence {θₜ} converges to a local minimum (or stationary point) of L(θ), and denoted is the limit θ*.

Because L(θ) is bounded below by Lₘᵢₙ and decreases with each update (neglecting small fluctuations), L(θₜ) converges to some L≥Lₘᵢₙ. In the special case that L is convex or satisfies the Polyak-Lojasiewicz condition, any stationary point is a global minimiser, so L*≥Lₘᵢₙ. In a more general nonconvex setting, θ* is a local minimiser. Still, the decreasing nature of L(θ) with diminishing temperature guarantees no repeated jumps away from a stable basin of attraction.

In a neighborhood of θ* (with ∇L(*)=0), ∇L(*+Δ)≈H(θ*) is approximate, where H(θ*) is the Hessian at θ*. Because θ* is (locally) minimal, H(θ*) is positive semidefinite. A small perturbation Δ increases L(θ) and the blockwise gradient descent step—ηƒ(t)∇L(θ) then pulls θ back toward θ*. Formally, a Lyapunov function V(θ)=L(θ)−L(θ*)≥0 is defined. For θ close to θ*, V(θₜ₊₁)−V(θₜ)=L(θₜ₊₁)−L(θₜ)≈−ηƒ(ƒ)∥∇L(θₜ)∥² is obtained, which is non-positive and equals zero if ∇L(θₜ)=0. Thus V(θₜ) is nonincreasing along trajectories and θ* is an equilibrium. If H(θ*) is positive definite, then small perturbations are corrected in a single update step, ensuring asymptotic stability.

Consequently, once θ* is reached, the system resists diverging from it; small displacements cause a restoring gradient pushing θ back to θ*. Thus θ* is Lyapunov-stable, addressing the reviewer's concern regarding stability under disturbances or annotation noise. Hence, combining these arguments, DF-GDA converges to a stable fixed point θ* (which is a stationary point of L(θ)), and does so monotonically in L(θ) once T≈0. That establishes the claimed results.

Extending the local and Lyapunov analyses, now proved is the global convergence of DF-GDA for general non-convex objectives: from any start, it reaches a stationary point, with a bounded iteration count to an ϵ-stationary solution. The necessary assumptions and definitions are now stated.

(A1) Smoothness. The loss L(θ) is continuously differentiable and has L—Lipschitz continuous gradients. In other words, there exists L>0 such that for all θ; θ′; ∥∇L(θ)−∇L(θ′)∥≤L∥θ−θ′∥.

(A2) Boundedness. The loss L(θ) is bounded below by Lₘᵢₙ (finite global infimum) and is coercive—i.e. L(θ)→∞ as ∥θ∥→∞.

(A3) Fraction schedule. The fraction of parameters updated, ƒ(t)∈(0,1], remains bounded away from 0. In particular, there exists a constant ƒₘᵢₙ>0 such that ƒ(t)≥ƒₘᵢₙ for all t.

(A4) Annealing schedule. The temperature Tₜ is scheduled so that the injected perturbation ϵ(Tₜ) vanishes as t→∞. Hence the noise term ξₜ: ϵ(Tₜ) [symbol] (0, I) has [symbol] [ξₜ]=0 and Var[ξₜ]→0 as t→∞.

Definition (Stationarity and ϵ-stationarity) A point θ* is a stationary point of L(θ) if ∇L(θ*)=0. For ϵ>0, θ is an ϵ stationary point if ∥∇L(θ)∥≤ϵ.

Theorem 7. Global Convergence of DF-GDA Suppose (A1)-(A4) hold. Let {θₜ} be the DF-GDA sequence θₜ₊₁θₜ−ηƒ(t)∇L(θₜ)+ξₜ, t=0, 1, 2, . . . , Then (a) {L(θₜ)} is non-increasing and converges to a finite limit L′≥Lₘᵢₙ;

(b) ∥∇L(θₜ)∥→0 as t→∞;

(c) the full sequence θₜ converges to a stationary point θ* of L, and θ* is a (local) minimiser.

Proof. (i) Descent of L—Ignoring ξₜ, the deterministic update

$${θ}_{t + 1}^{( d )} = {θ}_{t} - η f ( t ) ∇ L ( {θ}_{t} ) ,$$

### by L-smoothness,

$$L ( {θ}_{t + 1}^{( d )} ) \leq L ( {θ}_{t} ) - η f ( t ) {‖ ∇ L ( {θ}_{t} ) ‖}^{2} + \frac{L {η}^{2} {f ( t )}^{2}}{2} {‖ ∇ L ( {θ}_{t} ) ‖}^{2} .$$

For η≤1/L this yields

$$L ( {θ}_{t + 1}^{( d )} \leq L ( {θ}_{t} ) - \frac{η f ( t )}{2} {‖ ∇ L ( {θ}_{t} ) ‖}^{2} .$$

The added noise is zero-mean and its variance decays (A4); hence [symbol] [L(θₜ₊₁)|θₜ]≤L(θₜ). Monotone convergence and boundedness below (A2) give L(θₜ)→L*.

(ii) Vanishing Gradient. Summing the descent bound and using

$$f ( t ) \geq {f}_{min} : \frac{η {f}_{min}}{2} {\sum }_{t = 0}^{∞} 𝔼 [ {‖ ∇ L ( {θ}_{t} ) ‖}^{2} ] \leq L ( {θ}_{0} ) - {L}^{*} \leq ∞ so$$

$$𝔼 [ {‖ ∇ L ( {θ}_{t} ) ‖}^{2} ] \to 0 ,$$

and almost surely ∥∇L(θₜ)∥→0.

(iii) Convergence of θₜ Coercivity (A2) implies {θₜ} lies in a compact sublevel set, hence has at least one limit point. If two distinct limit points existed, L(θₜ) could not converge to the single limit L*, contradiction. Therefore θₜ→θ* with ∇L(θ*)=0. Because L decreases along the trajectory, θ* cannot be a saddle or maximiser, so it is a local minimum.

Theorem 8. Iteration Complexity to ϵ-Stationarity Under (A1)-(A4) with η≤1/L, define the hitting time τ_{ϵ}:=min{t≥0: ∥∇L(θₜ)∥≤€}. Then

$$𝔼 [ {τ}_{ϵ} \} \leq \frac{2 [ L ( {θ}_{0} ) - {L}_{min} ]}{η {f}_{min} {ϵ}^{2}} i . e . 𝔼 [ {τ}_{ϵ} \} = 𝒪 ( 1 / {ϵ}^{2} ) .$$

Proof. Telescoping the descent inequality of Theorem 7 gives

$$\frac{η {f}_{min}}{2} {\sum }_{t = 1}^{N - 1} 𝔼 [ {‖ ∇ L ( {θ}_{t} ) ‖}^{2} ] \leq L ( {θ}_{0} ) - {L}_{min} .$$

If ∥∇L(θₜ)∥>ϵ for all t<N, the left-hand sum exceeds Nϵ², contradicting the inequality. Thus an ϵ-stationary iterate appears by step N, yielding the stated bound.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

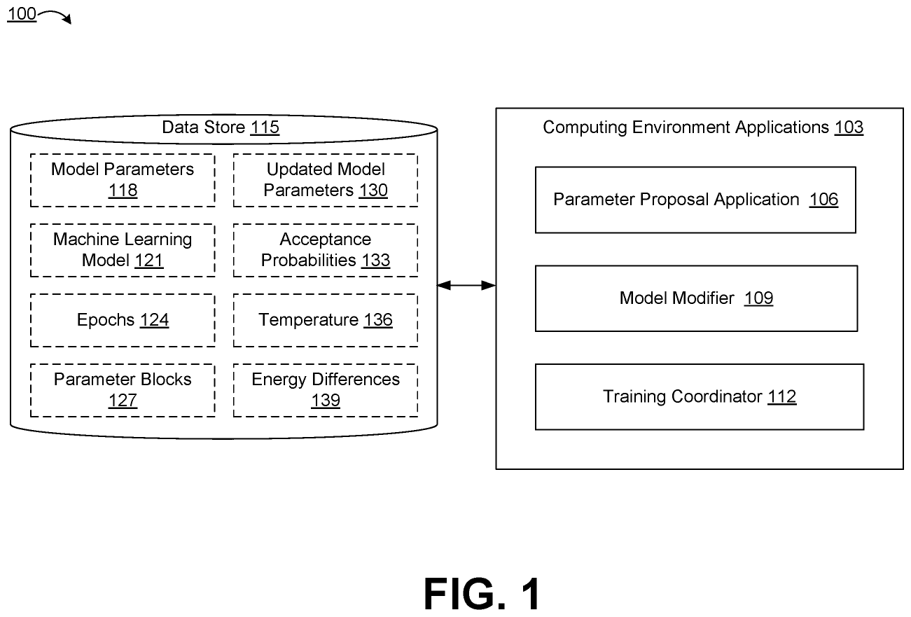

With reference to FIG. 1, shown is a computing environment 100 according to various embodiments. The computing environment 100 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 100 can employ a plurality of computing devices that can be arranged in one or more server banks or computer banks or other arrangements. Such computing devices can be located in a single installation or can be distributed among many different geographical locations. For example, the computing environment 100 can include a plurality of computing devices that together can include a hosted computing resource, a grid computing resource or any other distributed computing arrangement. In some cases, the computing environment 100 can correspond to an elastic computing resource where the allotted capacity of processing, network, storage, or other computing-related resources can vary over time.

Various applications or other functionality can be executed in the computing environment 100. The components executed on the computing environment 100 include computing environment applications 103, including a parameter proposal application 106, a model modifier 109, and a training coordinator 112, and other applications, services, processes, systems, engines, or functionality not discussed in detail herein.

The computing environment applications 103 are a grouping of applications that can be executed in the computing environment 100. According to various embodiments, the computing environment applications 103 can view and modify data in a data store 115. The computing environment applications 103 can connect to one another and to the data store 115 through any type of direct connection, shared memory, or network, wherein the network can include wide area networks (WANs), local area networks (LANs), personal area networks (PANs), or a combination thereof. The computing environment applications 103 can include a parameter proposal application 106, a model modifier 109, a training coordinator 112, and other applications not depicted.

The training coordinator 112 can be executed to apply dynamic fractional generalized deterministic annealing (DF-GDA) to the parameters 118 of a machine learning model 121. According to various embodiments, the training coordinator 112 can do so by orchestrating repeated dynamic fractional-parameter updates to the parameters 118 over a number of epochs 124 with changing variables, such as temperature 136. In some embodiments, the training coordinator 112 can also speed up the training by grouping sets of parameters 118 into parameter blocks 127 and orchestrating updates to parameter blocks 127 in parallel. To give an example of the operation of this application, the training coordinator 112 could split the weights and biases of a neural network into a plurality of parameter blocks 127, determine a number of epochs 124, and for each epoch 124, run a cycle of orchestrating the other applications to apply the dynamic fractional-parameter updates to the parameter blocks 127, while the training coordinator updates temperature 136 values.

The parameter proposal application 106 can be executed to propose updated model parameters 130. According to various embodiments, the parameter proposal application 106 can determine these updated model parameters 130 by applying a mean field update with noise to the parameters 118. The parameter proposal application 106 can also compute acceptance probabilities 133 corresponding to the new parameters 118. As an example, the parameter proposal application 106 can take parameters 118 corresponding to the weights and biases of a neural network, apply a mean field update to the parameters 118 to compute updated model parameters 130, then generate a corresponding set of acceptance probabilities 133.

The model modifier 109 can be executed to apply changes to model parameters 118. The model modifier 109 can receive the updated model parameters 130 and the acceptance probabilities 133. Based at least in part on the acceptance probabilities 133, the model modifier 109 can determine a subset of parameters 118 to swap out in the machine learning model 121 for the updated model parameters 130. According to various embodiments, updated model parameters 130 corresponding to higher acceptance probabilities 133 are more likely to be integrated into the model parameters 118. To build on the example of the neural network, the model modifier 109 could swap out weights and biases in the neural network based on the acceptance probabilities 133.

Also, various data is stored in a data store 115 that is accessible to the computing environment 100. The data store 115 can be representative of a plurality of data stores 115 which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 115 is associated with the operation of the various applications or functional entities described below. This data can include a machine learning model 121, model parameters 118, parameter blocks 127, temperatures 136, updated model parameters 130, acceptance probabilities 133, energy differences 139, epochs 124, and potentially other data.

The machine learning model 121 can represent any programmatic or mathematical object, function, or data that can be used to map inputs to outputs using model parameters 118. The machine learning model 121 can take many forms according to various embodiments, including but not limited to neural networks, adversarial neural networks, convolutional neural networks, regression models, deep learning models, clustering models, decision trees, support vector machines, Bayesian models, transformers, adversarial networks, ensemble models, and reinforcement models. A Large Language Model would represent an example of a machine learning model 121 according to various embodiments.

The model parameters 118 can represent variables that are factored into the calculations of outputs based on inputs. According to various embodiments, parameters 118 can influence the weights of certain inputs with respect to the outputs. Several examples of parameters 118 are present into various embodiments, such as the weights and biases in a neural network, the adjustable variables in a regression model, and comparison values in a decision tree.

The parameter blocks 127 can represent groupings of model parameters 118. The parameters 118 can be grouped into parameter blocks 127 to allow for parallel processing of the parameter blocks 127. This can speed up the optimization of the parameters 118 as compared to sequential processing of all the parameters 118. As an example, the parameters 118 of a large neural network can be split into several blocks and quickly processed by using hardware capable of parallel processing, such as GPUs or multiple processors.

The temperatures 136 can represent values that impact the extent to which model parameters 118 can change. In certain embodiments, the temperatures 136 can affect the degree of hardness in soft quantization and the number of parameters 118 updated at once. The temperature values 136 can be decreased over time so that the parameters 118 are changed rapidly at first and gradually change less dramatically over time as the parameters 118 approach an optimal state. As an example, a temperature 136 could be set at a value of one to start and then be decreased over multiple epochs 124 to nearly zero, reflecting a system that was initially very prone to change but slowly became more stable in terms of the parameter values 118.

The updated model parameters 130 can represent model parameters 118 that have been modified by the parameter proposal application 106. The update can represent a step or a change in parameters 118 to attempt to improve the model 121 and can be based on a mean value update of the parameters 118. For example, the updated model parameters 130 for a neural network could be generated by applying a mean value update to the parameters 118 corresponding to the weights and biases of the network.

The acceptance probabilities 133 can represent likelihoods for the various updated parameters 130 to be integrated into the model parameters 118. According to various embodiments, the acceptance probabilities 133 can be calculated based at least in part on the temperature 136 and the total energy differences 139 between the updated parameters 130 and the model parameters 118. For example, an acceptance probability 133 could be calculated to be

$${P}_{a c cept} = \frac{1}{1 + exp ( Δ E / T )}$$

where ΔE represents the energy differences 139 and T represents temperature 136.

The energy differences 139 can represent differences between the energy level of different soft quantized states of parameters 118. According to various embodiments, energy can be a function of loss and temperature 136. An energy function can be given by

$$E ( θ , T ) = L ( θ ) + \frac{λ}{T} {\sum }_{i = 1} n \vert {θ}_{i} = {θ}_{i}^{′} \vert$$

where n is the number of parameters, λ is a regularization parameter, and θᵢ′ are the potential new states of the parameters 118 after applying soft quantization discussed below. Then, an energy difference 139 could, for example, be given by

$${δ}_{i k} = \vert {θ}_{i} - {q}_{k} \vert - \vert {θ}_{i} - {q}_{{k}_{o p t}}^{( i )} \vert$$

to denote the energy difference 139 between state qₖ and the optimal state for θᵢ.

The epochs 124 can represent complete passes through training data during the optimization of the model parameters 118. According to certain embodiments, each parameter block 127 of parameters 118 can be updated at least once during an epoch 124. The number of epochs 124 can be predefined and determine the amount of updates and training to apply to the parameters 118. As a non-limiting example, there could be fifty epochs 124 for a set of parameters 118, ensuring that each parameter 118 has at least fifty opportunities to be updated.

Next, a general description of the operation of the various components of the computing environment 100 is provided. Although the following description provides one illustrative example of the operations of and interactions between the various components of the computing environment 100, other operations and interactions are also encompassed by the various embodiments of the present disclosure. More detailed discussion of the operations of individual components is provided in the discussion accompanying the subsequent drawings.

According to various embodiments, the training coordinator 112 can determine a set of parameters 118 corresponding to a machine learning model 121. The training coordinator 112 can set some initial values, such as a temperature 136, a maximum entropy, and divide the parameters into parameter blocks 127. Then, through a predefined number of epochs 124, the training coordinator 112 can repeatedly orchestrate the parameter proposal application 106 to generate a set of updated parameters 130 based on the parameters 118. The parameter proposal application 106 can calculate a number of parameters to update based on time, entropy, temperature 136, or other factors and apply a mean field update to the parameters 118, followed by soft quantization. The parameter proposal application 106 can additionally calculate an acceptance probability 133 or a set of acceptance probabilities 133 corresponding to the updated parameters 130.

In certain embodiments, the model modifier 109 can swap out parameters 118 for updated parameters 130 based on comparing randomly generated values to the acceptance probability 133. In other embodiments, the selection of parameters 118 can be performed deterministically, based on energy differences 139. Once the parameters 118 are updated, the training coordinator 112 can orchestrate the updating of the other parameter blocks 127, until an epoch 124 is complete. Between epochs 124, the training coordinator 112 can update values such as decreasing system temperature 136 or calculating entropy. Once all the epochs 124 are complete, the remaining parameters 118 corresponding to the model 121 can be selected as the optimized parameters 118. According to various embodiments, the updates to parameter blocks 127 can be Dynamic Fractional Parameter Updates (DFPUs). The DFPU is a mechanism that can be used within the larger Dynamic Fractional Generalized Deterministic Annealing (DF-GDA) optimization. The training coordinator 112 can orchestrate this larger DF-GDA optimization according to certain embodiments.

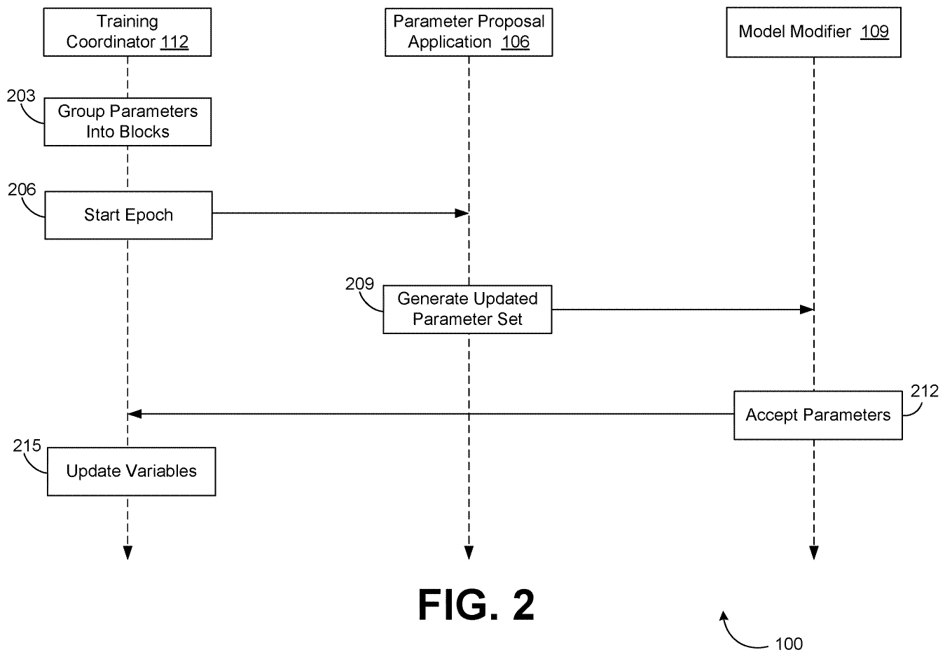

Referring next to FIG. 2, shown is a sequence diagram that provides one example of the operation of a portion of the applications in the computing environment 100. The sequence diagram of FIG. 2 provides merely an example of the many different types of functional arrangements that can be employed to implement the operation of the depicted portions of the computing environment 100.

Starting with block 203, the training coordinator 112 can group parameters 118 into parameter blocks 127. According to various embodiments, this can allow parallel operations to be performed on the parameters 118 during updates. As an example, the training coordinator 112 can start by dividing each weight in a neural network into one of several parameter blocks 127.

Moving to block 206, the training coordinator 112 can start an epoch 124. In certain embodiments, the training coordinator 112 can initialize different variables prior to starting the epoch 124, such setting an initial temperature 136 and determining a maximum entropy. When starting the epoch 124, the training coordinator 112 can trigger updates for multiple parameter blocks 127 in parallel, according to various embodiments. An example of starting the first epoch 124 could comprise the training coordinator 112 setting a very high initial temperature 136 and coordinating the parameter proposal application 106 to start generating updated parameters 130 for a subset of the weights in a neural network.

Looking next at block 209, the parameter proposal application 106 can generate an updated parameter set 130. This can be performed using a mean field update of the model parameters 118. In certain embodiments, the parameter proposal application 106 can apply soft quantization and noise to the updated parameter set 130 as well. The soft quantization can balance continuous space optimization with the stability of discrete space updates, preventing large, abrupt parameter jumps in high dimensional problems. In various embodiments, the parameter proposal application 106 can apply soft quantization to the updated parameters 130, based at least in part on a temperature 136 corresponding to the quantization. The parameter proposal application 106 can also determine a fractional number of parameters 118 to update at once based in part on the temperature 136, entropy, or other factors. This can help to improve the speed and efficiency of the optimization. To give a example of operations at block 209, the parameter proposal application 106 could generate updated parameters 130 for the dividing values of a decision tree wherein the parameter proposal application 106 has soft quantized the dividing values.

Continuing on to block 212, the model modifier 109 can select some of the updated parameters 130 to swap into the model parameters 118. According to various embodiments, an updated parameter 130 can be selected if a random selection of a value between 0 and 1 is greater than a respective acceptance probability 133. In certain embodiments, the updated parameters 130 can be selected deterministically based on energy differences 139 and temperature 136. The model modifier 109 can select a number of parameters 118 to update based at least in part on the fractional value calculated by the parameter proposal application 106. To give an example of the operation at block 212, if an updated parameter 130 for neural network's weight corresponded to an acceptance probability 133 of 0.5, a pseudorandom number between 0 and 1 could be generated, and if that number is 0.5 or greater, that updated parameter 130 can be swapped into the neural network's weights.

Looking next at block 215, the training coordinator can adjust different variables after the update. According to various embodiments, these adjustments can comprise changing the temperature 136 of the system and calculating a total entropy of the system. For example, after the model 121 is modified, the temperature 136 of the system can be slightly decreased, and the entropy can be recalculated based on the new model parameters 118. This can help to move the system towards a stable solution while avoiding local minima.

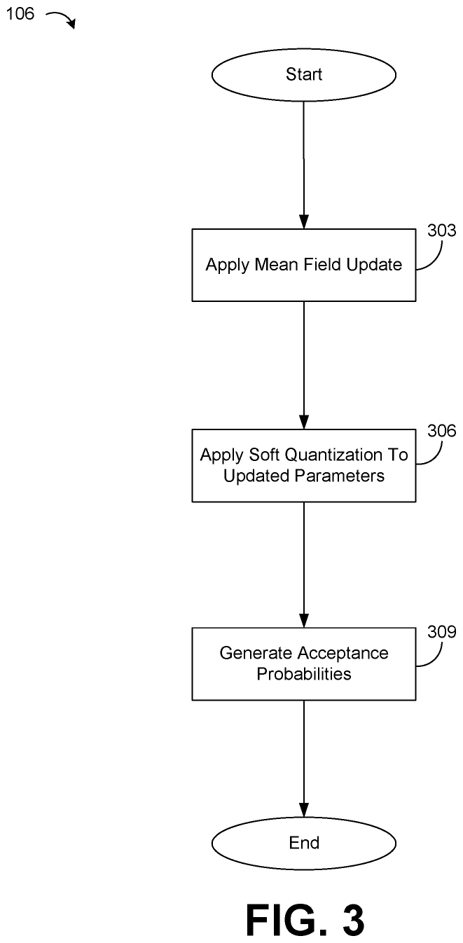

Turning now to FIG. 3, shown is a flowchart that provides one example of the operation of a portion of the parameter proposal application 106. The flowchart of FIG. 3 provides merely an example of the many different types of functional arrangements that can be employed to implement the operation of the depicted portion of the parameter proposal application 106.

Starting with block 303, the parameter proposal application 106 can apply a mean field update to a set of parameters 118. According to various embodiments, the mean field update can use the derivative of a loss function ∇L(θᵢ) to smooth over time:

$${μ}_{i}^{( t + 1 )} = {μ}_{i}^{( t )} + ( 1 - α ) ∇ L ( {θ}_{i}^{( t )} )$$

where α is a smoothing coefficient that controls how much current values are weighted versus the historical average. For example, mean field derivates can be updated according to μᵢ←μᵢ+(1−α)∇ [symbol] (θᵢ), and an updated parameter 130, θ′ᵢ, can be proposed using the mean field update and noise according to

$${θ}_{i}^{′} = {θ}_{i} - η {μ}_{i} + ϵ ( T ) * 𝒩 ( 0 , I ) .$$

Looking next to block 306, the parameter proposal application 106 can apply soft quantization to the updated parameters 130. According to various embodiments, soft quantization can ensure smooth transitions in parameter states, reducing sensitivity to fluctuations caused by annotation noise. This approach can maintain stability during training by keeping parameter 118 adjustments more controlled. Soft quantization balances continuous space optimization with the stability of discrete space updates and can prevent large, abrupt parameter jumps in high dimensional problems like deep neural networks. Unlike hard quantization, which forces parameters to snap to the nearest state, soft quantization allows them to probabilistically explore nearby states, promoting smoother transitions while maintaining structure and stability. This approach can enhance both flexibility and robustness in parameter updates. As an example of the operation at block 306, the parameter proposal application 106 can apply soft quantization to the updated parameters 130 according to

$${θ}_{i}^{′} = {\sum }_{k = 1}^{K} {q}_{k} \cdot \frac{exp ( - \vert {θ}_{i}^{′} - {q}_{k} \vert / {T}_{q} )}{{\sum }_{j = 1}^{K} exp ( - \vert {θ}_{i}^{′} - {q}_{j} \vert / {T}_{q} )} .$$

Looking next to block 309, the parameter proposal application 106 can generate acceptance probabilities 133. The probabilistic acceptance allows the optimization technique to accept suboptimal solutions based on energy differences, bypassing noise-induced local minima. This feature can enable improved exploration in noisy environments. According to various embodiments, the acceptance probabilities 133 can correspond various updated parameters 130 in a parameter block 127. According to other embodiments, the acceptance probability 133 can be the same for all parameters 118 in a parameter block 127. An example of the calculation of an acceptance probability can be given by

$${P}_{a c cept} = \frac{1}{1 + exp ( Δ E / T )}$$

wherein ΔE is an energy difference 139 and T is a temperature 136.

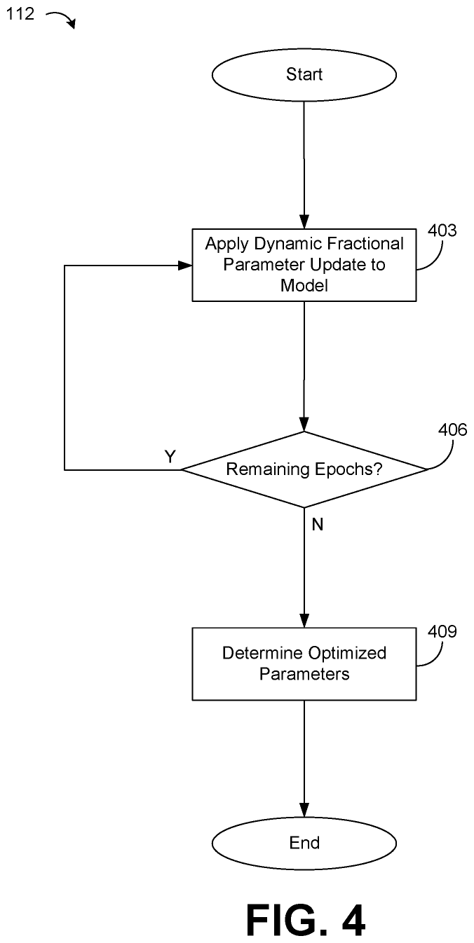

Moving on to FIG. 4, shown is a flowchart that provides one example of the operation of a portion of the training coordinator 112. The flowchart of FIG. 4 provides merely an example of the many different types of functional arrangements that can be employed to implement the operation of the depicted portion of the training coordinator 112.

Beginning with block 403, the training coordinator 112 can orchestrate applying dynamic fractional parameter updates (DFPU) to the model 121. According to various embodiments, the DFPU algorithm can be applied to each parameter block 127 during an epoch 124. The DFPU algorithm can take advantage of the proportion of model parameters 118 that are to be updated during each iteration. The algorithm can be sensitively adjusted on the basis of the current status of the training, including the rate of change in the loss function to ensure a balanced trade-off between exploration and exploitation throughout training. Block 209 and block 212 of FIG. 2 together provide an example of a embodiment of a DFPU.

Moving on to block 406, the training coordinator 112 can check whether any epochs 124 remain in the training. According to various embodiments, there can be a predetermined number of epochs 124 with which to optimize a set of model parameters 118. If there are remaining epochs 124, the training coordinator 112 can continue applying the DFPU algorithm to the parameters 118 as at block 403. If there are not any remaining epochs 124, the training coordinator 112 can move to block 409. For example, if there were seventy epochs 124 by which to optimize a set of parameters 118, block 403 could be repeated until all seventy epochs 124 are exhausted.

Concluding with block 409, the training coordinator 112 can determine a set of optimized parameters 118. According to various embodiments, these optimized parameters 118 can be equivalent to or related to the final set of parameters 118 after all the epochs 124 conclude. According to certain embodiments, there is a mathematical guarantee that a stable solution will be reached as the temperature 136 is lowered. To give an example, after the epochs 124 conclude, the final set of parameters 118 produced from repeatedly applying DFPU could be selected as the set of optimized parameters 118 with a theoretical guarantee that the parameters 118 are the stable solution to which the optimization converged.

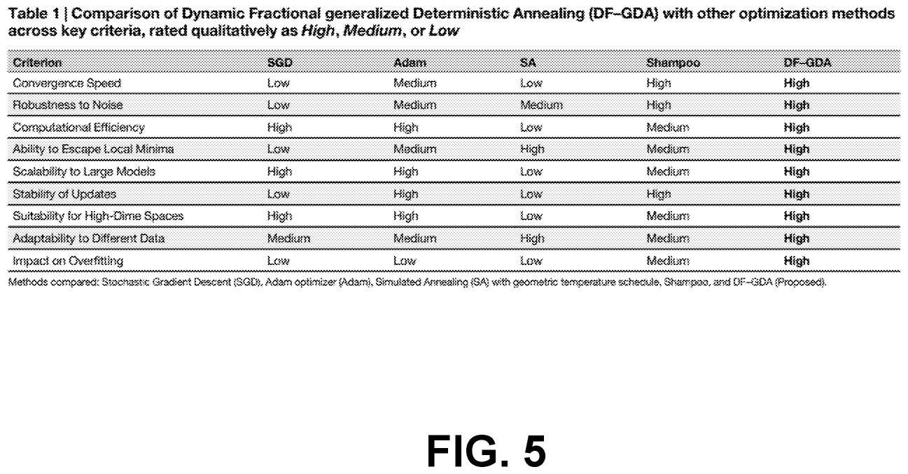

Turning next to FIG. 5, shown is a table that provides a comparative analysis of Dynamic Fractional generalized Deterministic Annealing (DF-GDA) against widely used optimization methods, including Stochastic Gradient Descent (SGD), the Adam optimizer, Simulated Annealing (SA), and Shampoo. The table evaluates key performance metrics such as convergence speed, robustness to noise, computational efficiency, and the ability to escape local minima. DF-GDA consistently outperforms the other methods across these criteria, particularly excelling in convergence speed, robustness to noise, and stability of updates.

Shampoo leverages block-diagonal second-order pre-conditioning to achieve fast and stable convergence, yet incurs medium computational cost and memory overhead relative to first-order optimizers. While SGD and Adam demonstrate strengths in computational efficiency and scalability, they struggle with local minima and noise sensitivity. SA(with geometric temperature schedule), despite its capability to escape local minima, suffers from slow convergence and high computational cost. In contrast, DF-GDA employs adaptive fractional updates and entropy-driven annealing to deliver superior optimization performance, making it a highly effective alternative for complex deep-learning tasks.

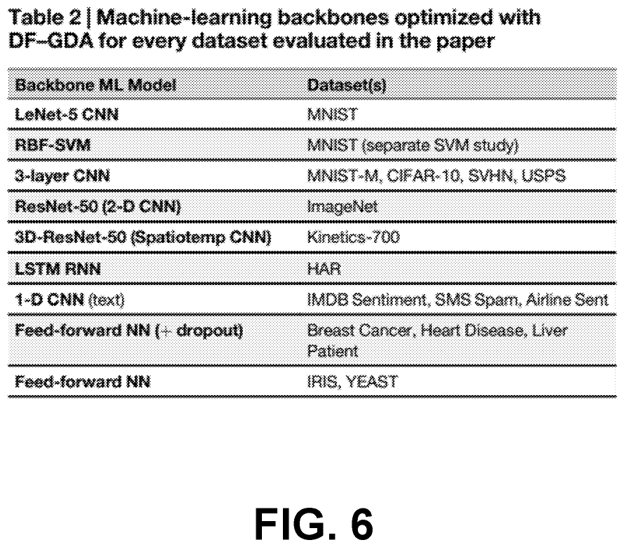

Looking next at FIG. 6, shown is a table that concisely maps each backbone machine learning model optimized with DF-GDA to the broad data modality it tackles. Lightweight CNNs (LeNet-5, a 3-layer CNN) were deployed for small-sized image tasks, an RBF-SVM to probe kernel methods on similar inputs, and a deep ResNet-50 for largescale natural-image classification. For spatiotemporal video benchmarks 3D-ResNet-50 was used, while sequential sensor data are handled with an LSTM. A 1-D CNN covers short-text sentiment problems, and two fully-connected networks address structured tabular biomedical records and classic low-dimensional datasets.

In the experiments, for the dynamic fractional parameters update, ƒₘᵢₙ=0.01 and ƒₘₐₓ=0.5 were set. The optimal number of Markov states was 1024 and 512, depending on the datasets in the experiments. All experiments were carried out using PyTorch 1.12.1 on a server equipped with dual Nvidia RTX 3090 GPUs (24 GB VRAM each), an AMD Ryzen Threadripper 3990X 64-core processor, and 256 GB of RAM. Additionally, (ƒₘᵢₙ, ƒₘₐₓ)=(0.01, 0.50) was set for all experiments. Two properties make this single pair universally effective. Because the exponent uses normalized loss change, ƒ(t) reacts to fractional progress rather than absolute loss values, yielding comparable behavior across tasks whose losses differ by orders of magnitude. With ƒₘₐₓ≤0.5, the sufficient-descent condition in Theorem 3 holds for any Lipschitz-smooth objective, ensuring monotone loss decrease and convergence regardless of the dataset. The pair chosen on CIFAR-10 was frozen for all other benchmarks (vision, NLP, healthcare, bio-informatics) and still delivered state-of-the-art performance

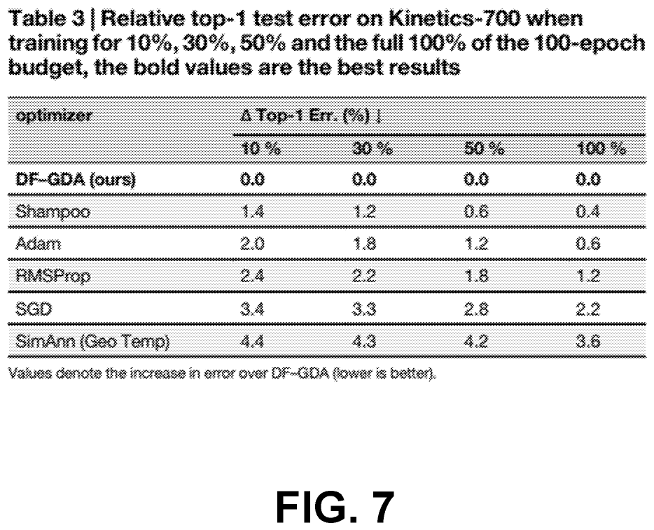

Moving next to FIG. 7, the table reports the relative top-1 test error of several popular optimizers with respect to the baseline DF-GDA. Across all training budgets—even after 10% of the 100-epoch schedule—DF-GDA maintains a 0% error increase, confirming its superior sample efficiency. The closest competitor, Shampoo, a second-order optimization method, still lags by 1.4% early on and by 0.4% after full convergence, indicating that second-order curvature alone is insufficient to match DF-GDA's fractional annealing. First-order methods exhibit a larger gap. Adam trails by up to 2.0% and SGD by 3.4% in the under-trained regime, suggesting slower optimization dynamics. RMSProp performs better than SGD but is still behind in more modern optimization techniques. Finally, Simulated Annealing with geometric temperature schedule (SimAnn) remains consistently behind, highlighting that naive temperature schedules cannot bridge the performance deficit.

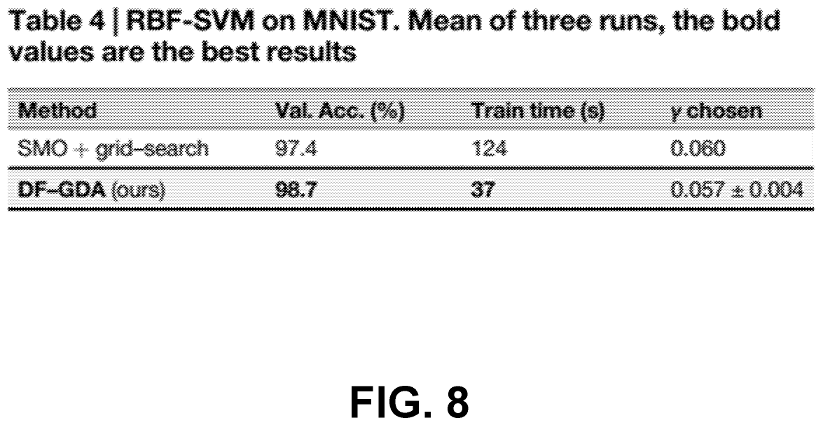

Next, the table in FIG. 8 shows the obtained results for SVM. DF-GDA achieves a higher accuracy while reducing training time by over 3×thanks to fractional updates and the elimination of grid search. The automatically annealed γ converges to the same range selected by exhaustive search, confirming the stability of the joint optimization.

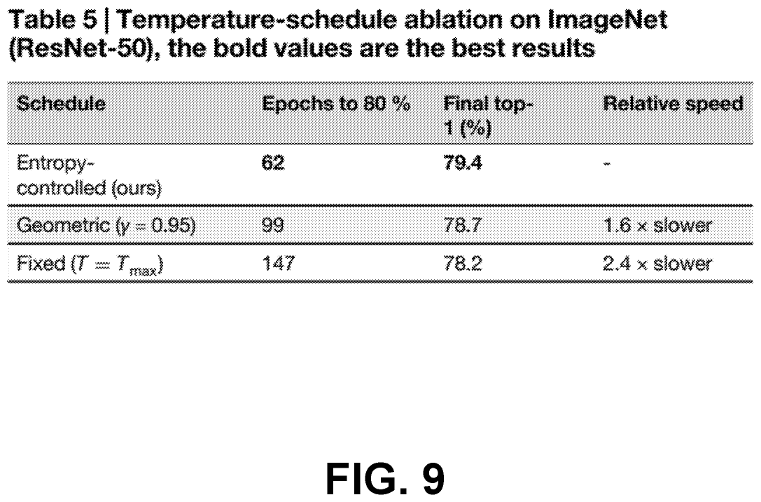

Turning to FIG. 9, the table compares the entropy-controlled schedule with (i) geometric cooling and (ii) a fixed temperature on ImageNet (ResNet-50). The entropy-controlled schedule attains 80% top-1 accuracy in 62 epochs versus 99 (geometric) and 147 (fixed) and delivers the best final accuracy.

Looking now at FIG. 10, the reports two runtime metrics: (i) average wall-clock time per ImageNet epoch (per-step cost) and (ii) total hours to reach the 80% top-1 accuracy milestone for ResNet-50—high enough to mark competitive performance yet attainable by all baselines. Although DFGDA's epoch is ~12% longer than SGD's, its sharper loss decline allows it to hit the 80% milestone 4-6 hours sooner than first-order baselines, more than twice as fast as the second-order Shampoo, and over ninefold faster than Simulated Annealing. The table also indicates the final accuracy of different methods, showing the method of this disclosure outperforms others.

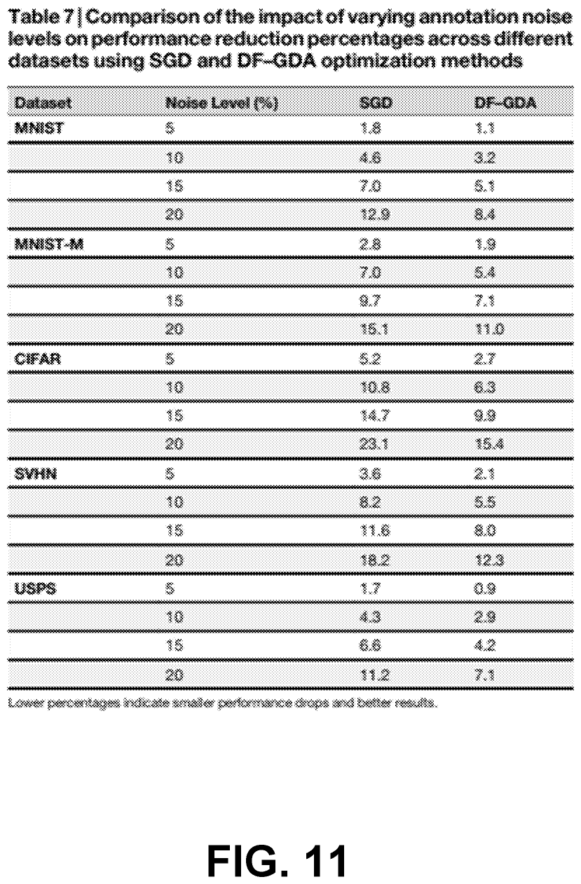

Moving next to FIG. 11, the experimental results in the table demonstrate the superior robustness of DF-GDA in the presence of annotation noise, compared to SGD across multiple datasets. When testing with artificially introduced label noise ranging from 5% to 20%, DF-GDA consistently shows smaller performance degradation than SGD. At 5% noise, DF-GDA's performance drops by 0.9% and 1.1% for USPS and MNIST, respectively, compared to SGD's 1.7% and 1.8%. Even at high noise levels (20%), DF-GDA maintains its advantage, showing a 15.4% drop on CIFAR versus SGD's 23.1%. This enhanced noise resilience, observed consistently across datasets including challenging ones like MNIST-M, demonstrates that DF-GDA's structured, adaptive approach effectively prevents convergence to suboptimal states in the presence of noisy labels.

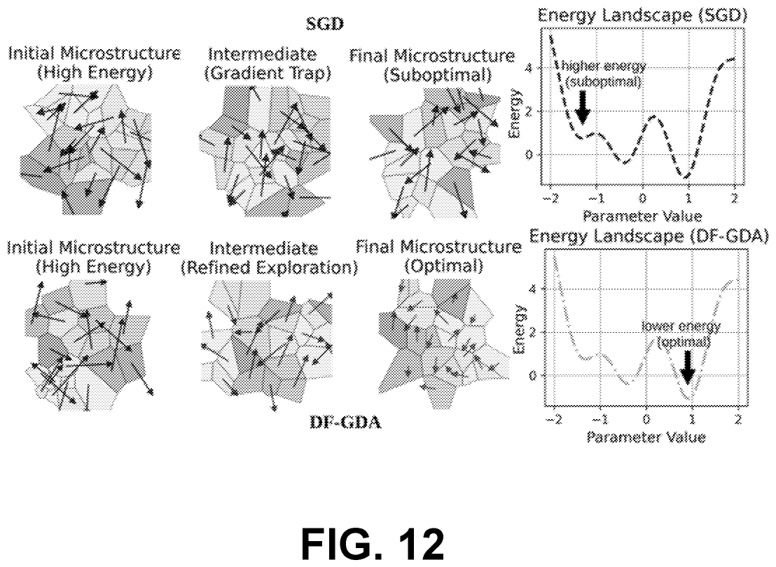

Looking to FIG. 12, the diagram shows the comparison of two optimization methods: stochastic gradient descent (SGD) and dynamic fractional generalized deterministic annealing (DF-GDA). Initially, both methods start with a high-energy, disordered microstructure. In the intermediate phase, SGD displays chaotic updates and often gets stuck in local minima, leading to a continued disordered state depicted by erratic arrows in both magnitude and direction. On the other hand, DF-GDA shows controlled and localized updates (organized arrows), allowing for a structured transition toward an optimal configuration. In the final phase, SGD remains trapped in a suboptimal state with a disordered microstructure, while DF-GDA reaches an optimal state with a well-organized microstructure. The energy landscape graphs illustrate these outcomes. SGD's energy graph remains at higher energy levels, indicating local minima entrapment. In contrast, DF-GDA's energy graph descends to lower energy levels, indicating successful convergence to a more optimal solution.

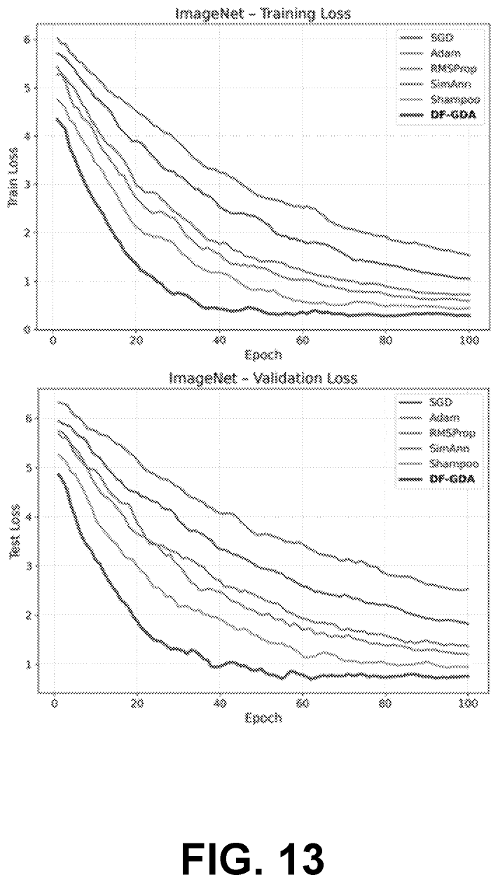

Turning to FIG. 13, the graphs show a comparison of training (top) and validation (bottom) cross-entropy loss between the proposed DF-GDA and five competing optimizers on ImageNet (one hundred epochs). DF-GDA descends fastest and converges to the lowest loss, with second-order Shampoo a distant second and first-order and standard simulated annealing baseline (SimAnn with geometric schedule) further behind.

Now considering FIG. 14, the graphs show temperature schedules and fractions. The leftmost graph shows the adaptive annealing temperature schedules for five datasets, MNIST, MNIST-M, CIFAR, SVHN, and USPS. The middle graph is related to the fraction of parameters used during different training epochs for five datasets (MNIST, MNIST-M, CIFAR, SVHN, and USPS). The far-right graph is related to the average fraction of parameters used across different epochs for the datasets.

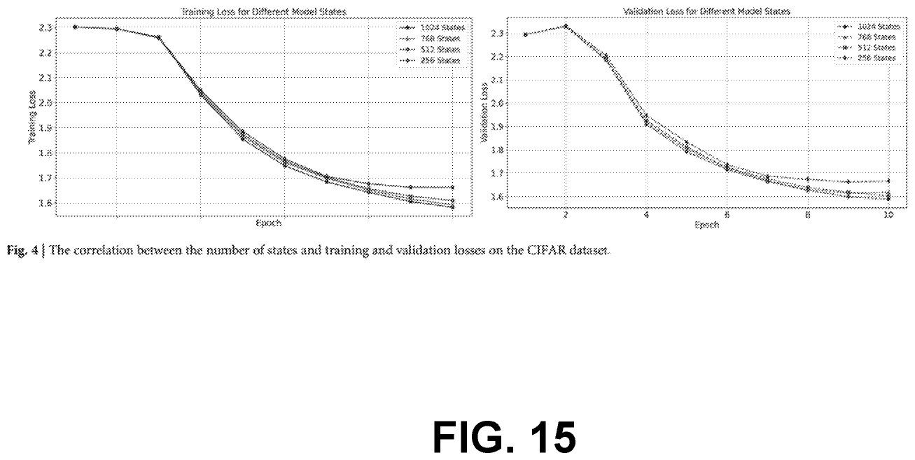

Looking at FIG. 15, the graphs show training and validation loss over ten epochs for models with different state sizes. All models exhibit rapid convergence, with initially higher losses for larger states but similar final performance across configurations. This suggests that smaller models may achieve comparable accuracy with reduced computational demands, making them more efficient for deployment.

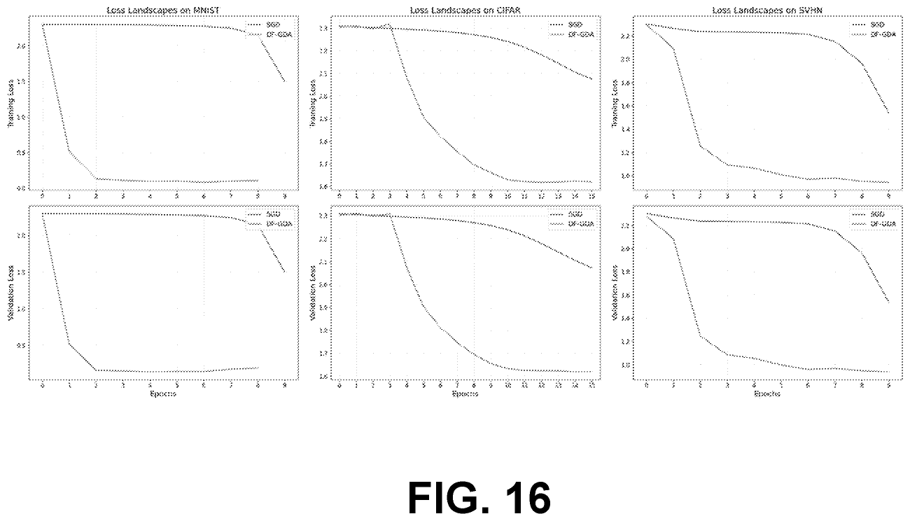

Moving on to FIG. 16, the graphs show a comparison of training and validation losses between SGD and DF-GDA on the image classification datasets, MNIST, CIFAR, and SVHN datasets.

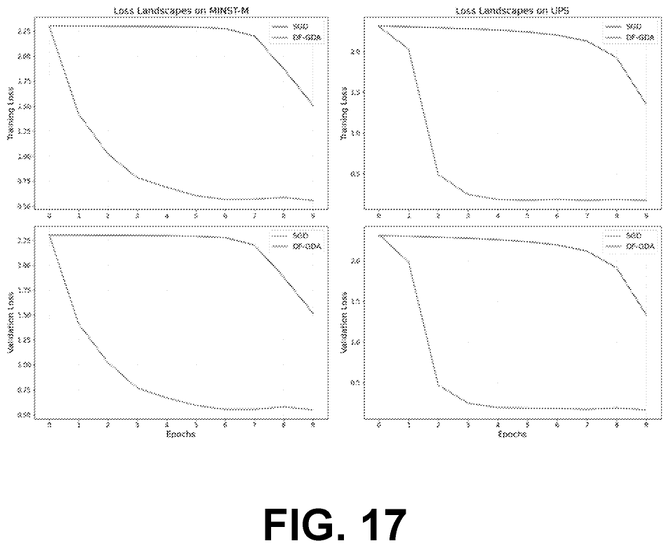

Moving on to FIG. 17, the graphs show a comparison of training and validation losses between SGD and DF-GDA on the MINST-M and USPS dataset.

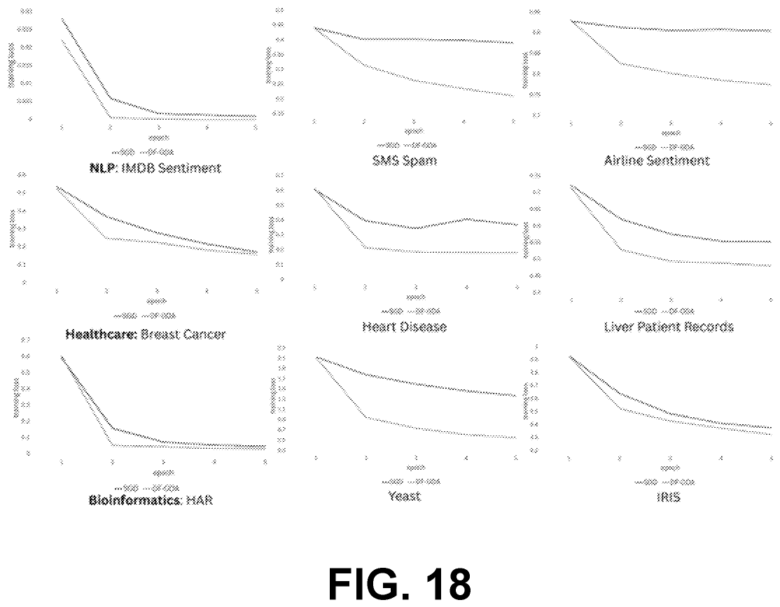

Looking now at FIG. 18, the graphs show a comparison of training losses between SGD and DF-GDA on interdisciplinary benchmarks: Natural Language Processing (IMDB Sentiment, SMS Spam, and Airline Sentiment), Healthcare (Breast Cancer Wisconsin, Heart Disease, and Liver Patient Records), and Bioinformatics (Human Activity Recognition, Yeast, and IRIS).

Concluding with FIG. 19, the graphical diagram illustrates how the proposed DF-GDA introduces a blockwise dynamic fractional parameter update method to update a fraction of the parameters 118 in each iteration, covering all the model's parameters 118 and data samples in an epoch 124, making it more efficient than the traditional optimization algorithms that update all the parameters 118.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 100.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A method, comprising:
modifying a machine learning model with a Dynamic Fractional Parameter Update (DFPU), the DFPU comprising at least:
identifying a subset of parameters from a set of parameters corresponding to the machine learning model;
proposing an updated subset of parameters based at least in part on applying a mean field update to the subset of parameters;
determining a set of acceptance probabilities based at least in part on a temperature value and a set of energy differences between the subset of parameters and the updated subset of parameters; and
accepting one or more updated parameters from the updated subset of parameters, based at least in part on the set of acceptance probabilities.

2. The method of claim 1, further comprising:
applying soft quantization to the updated subset of parameters, wherein a measure of hardness of the soft quantization is related to a quantization temperature.

3. The method of claim 1, further comprising:
grouping the set of parameters correspond to the machine learning model into non-overlapping blocks; and
applying the DFPU to at least two blocks in parallel.

4. The method of claim 1, further comprising:
setting the temperature value based at least in part on a maximum energy difference between any two quantized states for a parameter; and
adjusting the temperature value based at least in part on a total entropy calculated for the set of parameters.

5. The method of claim 1, further comprising:
repeatedly applying the DFPU to the machine learning model over a pre-determined number of epochs; and
determining an optimized set of parameters based on the set of parameters corresponding to the machine learning model after the DFPU.

6. The method of claim 1, further comprising:
determining a number of parameters to include in the subset of parameters based at least in part on a change in loss associated with the set of parameters.

7. The method of claim 1, further comprising using noise in determining the set of acceptance probabilities.

8. A system, comprising:
a computing device comprising a processor and a memory; and
machine-readable instructions stored in the memory that, when executed by the processor, modify a machine learning model by causing the computing device to at least:
identify a subset of parameters from a set of parameters corresponding to the machine learning model, wherein a size of the subset of parameters is based at least in part on a change in loss associated with the set of parameters;
propose an updated subset of parameters based at least in part on applying a mean field update with noise and applying soft quantization to the subset of parameters;
determine a set of acceptance probabilities based at least in part on a temperature value and a set of energy differences between the subset of parameters and the updated subset of parameters;
accept one or more updated parameters from the updated subset of parameters, based at least in part on the set of acceptance probabilities; and
adjust the temperature value based at least in part on a total entropy calculated for the set of parameters.

9. The system of claim 8, wherein a measure of hardness of the soft quantization is related to a quantization temperature.

10. The system of claim 8, wherein the machine-readable instructions further cause the computing device to at least:
group the set of parameters correspond to the machine learning model into non-overlapping blocks; and
update parameters in at least two blocks in parallel.

11. The system of claim 8, wherein the machine-readable instructions further cause the computing device to at least set the temperature value based at least in part on a maximum energy difference between any two quantized states for a parameter.

12. The system of claim 8, wherein the machine learning model is one of a neural network, a transformer, or a large language model.

13. The system of claim 8, wherein the machine learning model is one of a support vector machine, a clustering model, or a regression model.

14. The system of claim 8, wherein the machine-readable instructions further cause the computing device to at least update parameters corresponding to the machine learning model over a pre-determined number of epochs.

15. A non-transitory, computer-readable medium, comprising machine-readable instructions that, when executed by a processor of a computing device, modify a neural network with a Dynamic Fractional Parameter Update (DFPU), by causing the computing device to at least:
identify a subset of parameters from a set of parameters corresponding to the neural network;
propose an updated subset of parameters based at least in part on applying a mean field update to the subset of parameters;
determine a set of acceptance probabilities based at least in part on a temperature value and a set of energy differences between the subset of parameters and the updated subset of parameters; and
accept one or more updated parameters from the updated subset of parameters, based at least in part on the set of acceptance probabilities.

16. The non-transitory, computer-readable medium of claim 15, wherein the machine-readable instructions, when executed by the processor, further cause the computing device to at least:
apply soft quantization to the updated subset of parameters, wherein a measure of hardness of the soft quantization is related to a quantization temperature.

17. The non-transitory, computer-readable medium of claim 15, wherein the machine-readable instructions, when executed by the processor, further cause the computing device to at least:
group the set of parameters correspond to the neural network into non-overlapping blocks; and
apply the DFPU to at least two blocks in parallel.

18. The non-transitory, computer-readable medium of claim 15, wherein the machine-readable instructions, when executed by the processor, further cause the computing device to at least:
set the temperature value based at least in part on a maximum energy difference between any two quantized states for a parameter; and
adjust the temperature value based at least in part on a total entropy calculated for the set of parameters.

19. The non-transitory, computer-readable medium of claim 15, wherein the machine-readable instructions, when executed by the processor, further cause the computing device to at least:
repeatedly apply the DFPU to the neural network over a pre-determined number of epochs; and
determine an optimized set of parameters based on the set of parameters corresponding to the neural network after the DFPU.

20. The non-transitory, computer-readable medium of claim 15, wherein the machine-readable instructions, when executed by the processor, further cause the computing device to at least:
determine a number of parameters to include in the subset of parameters based at least in part on a change in loss associated with the set of parameters.
